(19) United States
(12) Patent Application Publication
(10) Pub. No.: US 2026/0211144 A1
(43) Pub. Date: Jul. 23, 2026

(54) RANDOMNESS IN SEISMIC SURVEY ACQUISITION

(71) Applicant: Schlumberger Technology Corporation, Sugar Land, TX (US)

(72) Inventors: Robert BLOOR, Houston, TX (US); Massimiliano VASSALLO, Crawley (GB); Ronan MC GUINNESS, Dubai (AE); Franck LE DIAGON, Crawley (GB); Rajiv KUMAR, Crawley (GB); Alexander ZARKHIDZE, Crawley (GB); Gary GEX, Houston, TX (US)

(21) Appl. No.: 19/136,917

(22) PCT Filed: Aug. 31, 2023
(86) PCT No.: PCT/US2023/031735

§ 371 Date: Jun. 9, 2025

Related U.S. Application Data
(60) Provisional application No. 63/476,267, filed on Dec. 20, 2022.

(51) Int. Cl. G01V 1/38

(52) U.S. Cl. CPC G01V 1/3808; G01V 1/3852

(57) ABSTRACT

Systems and techniques are provided for seismic acquisition operations. The displacements among activation positions of the seismic sources are random values or selected from a predefined list to accelerate progress to cover the area of interest. Regular or irregular perturbations (e.g., random values or selected from a predefined list) in a crossline direction are used for source line spacings and sail line move ups. The source line spacings are fixed or varied with respect to time during the seismic survey. The seismic sensors are spaced at regular or irregular intervals. Complete coverage are attained by performing interpolation techniques to the acquired seismic data. An image reconstruction from the collected seismic survey data, which are processed with compressive sensing techniques before the reconstruction, are generated based in part on an inversion technique or an imaging algorithm.

### CROSS-REFERENCE TO RELATED APPLICATIONS

This application claims priority to U.S. Provisional Patent App. No. 63/476,267, filed Dec. 20, 2022, entitled “RANDOMNESS IN SEISMIC SURVEY ACQUISITION,” the disclosure of which is incorporated by reference in its entirety for all purposes.

### BACKGROUND

The present disclosure relates generally to performing seismic surveys. In particular, the present disclosure generally relates to performing seismic surveys in land and marine environments, including transition zones.

This section is intended to introduce the reader to various aspects of art that may be related to various aspects of the present disclosure, which are described and/or claimed below. This discussion is believed to help provide the reader with background information to facilitate a better understanding of the various aspects of the present disclosure. Accordingly, it is understood that these statements are to be read in this light, and not as admissions of prior art.

Seismic exploration in areas having complex geological structures may be challenging. For example, in some regions, such as the Gulf of Mexico, the subsurface layers are often peppered with salt bodies, which are vast accumulations of salt formed millions of years ago deep inside the Earth. Salt is a low-density, buoyant substance, meaning that salt bodies gradually rise through the Earth's crust over time. The salt bodies may cause stress-related complexities between the salt and the surrounding subsurface layers. Furthermore, the salt's crystal structure may cause random reflections of seismic waves (e.g., soundwaves), therefore no sufficiently useable low frequencies are present in the seismic data acquired in the areas having salt bodies.

The majority of seismic data in the areas with complex geology have been acquired with towed streamer geometries (Narrow Azimuth, Wide Azimuth, or full Azimuth, shooting in turns, coil or dual coil), which may generate relatively accurate velocity model and image reservoirs. However, certain important details may not be revealed, such as below the complex geological bodies (e.g., subsalt) and at depth. Accordingly, a need exists for a method to derive detailed subsurface velocity models in complex geological areas.

### BRIEF DESCRIPTION OF THE DRAWING

These and other features, aspects, and advantages of the present disclosure will become better understood when the following detailed description is read with reference to the accompanying drawings in which like characters represent like parts throughout the drawings, wherein:

FIG. 1 is a schematic diagram of a seismic survey using different seismic measurements based on reflection waves, according to an embodiment of the present disclosure;

FIG. 2 is a schematic diagram of a seismic survey using different seismic measurements based on diving or refraction waves, according to an embodiment of the present disclosure;

FIG. 3 is an example of ocean bottom node (OBN) measurement with a regular pattern of nodes that may be employed in the seismic survey of FIG. 2, according to an embodiment of the present disclosure;

FIG. 4 is an example of OBN measurement with an alternative pattern of nodes that may be employed in the seismic survey of FIG. 2, according to an embodiment of the present disclosure;

FIG. 5 is an example of OBN measurement with an irregular pattern of nodes that may be employed in the seismic survey of FIG. 2, according to an embodiment of the present disclosure;

FIG. 6 is an example of OBN measurement with an irregular pattern of nodes adjusted to subsurface properties that may be employed in the seismic survey of FIG. 2, according to an embodiment of the present disclosure;

FIG. 7 is an example of OBN measurement with a regular pattern of seismic sources that may be employed in the seismic survey of FIG. 2, according to an embodiment of the present disclosure;

FIG. 8 is an example of OBN measurement with a sparse pattern of seismic sources that may be employed in the seismic survey of FIG. 2, according to an embodiment of the present disclosure;

FIG. 9 is an example of OBN measurement with an irregular pattern of seismic sources that may be employed in the seismic survey of FIG. 2, according to an embodiment of the present disclosure;

FIG. 10 is an example of OBN measurement with an irregular pattern of seismic sources adjusted to subsurface properties that may be employed in the seismic survey of FIG. 2, according to an embodiment of the present disclosure;

FIGS. 11A, 11B, and 11C are examples of OBN surveys having different node designs that may be employed in the seismic survey of FIG. 2, according to an embodiment of the present disclosure;

FIGS. 12A, 12B, and 12C are examples of OBN surveys having different dense node designs that may be employed in the seismic survey of FIG. 2, according to an embodiment of the present disclosure;

FIGS. 13A, 13B, and 13C are examples of OBN surveys having different sparse node designs that may be employed in the seismic survey of FIG. 2, according to an embodiment of the present disclosure;

FIGS. 14A, 14B, and 14C are examples of OBN surveys having different hybrid node designs that may be employed in the seismic survey of FIG. 2, according to an embodiment of the present disclosure;

FIGS. 15A, 15B, and 15C are examples of seismic source lines configurations generated by a source boat that may be employed in the seismic survey of FIG. 2, according to an embodiment of the present disclosure;

FIGS. 16A, 16B, and 16C are examples of sail lines and seismic source lines configurations for the source boat that may be employed in the seismic survey of FIG. 2, according to an embodiment of the present disclosure;

FIGS. 17A and 17B are examples of seismic sources, sail lines, and source lines configurations that may be employed in the seismic survey of FIG. 2, according to an embodiment of the present disclosure;

FIGS. 18A, 18B, and 18C are examples of seismic sources and sail lines that may be employed in the seismic survey of FIG. 2, according to an embodiment of the present disclosure;

FIGS. 19A and 19B are examples of seismic sources, sail lines, and source lines configurations that may be employed in the seismic survey of FIG. 2, according to an embodiment of the present disclosure;

FIGS. 20A and 20B are examples of seismic sources, sail lines, and source lines configurations that may be employed in the seismic survey of FIG. 2, according to an embodiment of the present disclosure;

FIG. 21 is a flow diagram of a process 500 for acquiring seismic data using the seismic sources and ocean bottom nodes (OBN) of FIGS. 3-20, according to an embodiment of the present disclosure; and

FIG. 22 is a schematic diagram of a seismic survey at a transition zone, according to an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components.

Certain terms are used throughout the description and claims to refer to particular features or components. As one skilled in the art will appreciate, different persons may refer to the same feature or component by different names. This document does not intend to distinguish between components or features that differ in name, but not function.

Prospecting for hydrocarbon deposits (e.g., oil and gas) often involves seismic exploration to determine subterranean geologic structures (e.g., subsurface layers or formations) by means of prospector-induced seismic waves. The seismic exploration may use a seismic survey to acquire seismic data for investigating subterranean structures related to hydrocarbons. For example, during a land (onshore) or a marine (offshore) seismic survey, the prospector-induced seismic waves (e.g., elastic or acoustic waves) may be generated by seismic sources (e.g., dynamite, electric vibrators, or air guns) located at selected shot points. The seismic waves may propagate downward into the subterranean geologic structures, which may change propagation directions (e.g., via reflections or refractions) and physical properties (e.g., amplitudes, phases, polarities) of the seismic waves due to changes in elastic properties (e.g., velocities, densities, or impedances) of the subterranean geologic structures.

For example, the seismic waves may include diving waves that may dive into the subsurface and then turn back again due to a gradual change (e.g., increase) in velocity with depth. Reflected or refracted seismic waves may propagate to pre-deployed sensors (e.g., geophones, accelerometers, hydrophones, fiber-optic sensors) that may detect and convert a portion of elastic or acoustic energy into signals recorded as the seismic data. The seismic data may be used to estimate geophysical properties (e.g., locations, formations, shapes) of the subterranean geologic structures. For example, the seismic data may be used to determine the locations of the subsurface layers or formations based on time intervals elapsing between initiations of seismic waves at the selected shot locations and arrivals of reflected or refracted seismic impulses detected at one or more sensors.

Certain complex geological bodies (e.g., salt bodies) may be within a close proximity to or include important subsurface structures with significant implications for hydrocarbon accumulation and sealing in offshore petroleum reservoirs. Accurate imaging and delineation of such complex geological bodies may be facilitated with the availability of three-dimensional (3D) seismic surveying. However, considering the growth of seismic data size, the efficiency of interpretation may increasingly rely on the development of powerful computational interpretation tools that are capable of mimicking an experienced interpreter's intelligence.

Previously, the majority of the seismic data in the areas with complex geology was recorded using towed streamer acquisitions. For example, in Gulf of Mexico (GOM) areas with vast salt bodies, the seismic data may be acquired using towed streamers with long offsets (e.g., up to 16 km or 18 km). The towed streamer data may yield velocity models and image pre-salt reservoirs with certain levels of accuracy. However, in some areas, such as below the complex geology (e.g., salt bodies), certain subsurface structure details may be missing.

Waveform inversion, such as Full Waveform Inversion, or FWI, recently emerged as an advanced method to derive detailed velocity model in any complex environments (e.g., complex salt bodies). FWI greatly benefits from certain seismic acquisition aspects, such as full azimuth, low frequency contents, and long offsets, which may deliver desired diving waves for FWI to work with. In the past, the towed streamer data was the only data available for FWI until sparse OBN data acquisition became a practical and cost-effective alternative. The sparse OBN data may be superior compared to the towed streamer data quality and easy to extend the offset length.

An ocean bottom geometry may be specifically designed to use ultra-long offsets (e.g., exceeding 50 km) for accuracy and efficiency. The sparse ocean bottom geometry may be designed for node density, source density, type of the source, type of shooting (e.g., with simultaneous source approach), size of apertures and haloes, and so on. Sometimes OBN geometries with relatively large distances between nodes is called sparse OBN acquisition.

Keeping this in mind, during seismic acquisition operations that employ the various types of seismic sensors mentioned above may employ towing seismic sources along different sail lines, such that sources may be activated in a periodic or regular manner to acquire continuous and regular coverage over the area of interest. In some embodiments of the present disclosure, the distance between each source line may be shifted, such that the distance between two source lines may be unequal from each other to accelerate progress to cover the area of interest. Indeed, complete coverage can be attained by performing interpolation techniques to the acquired seismic data based on an even or equal separation between the source lines (e.g., traditional regular move up). To improve the regular representation of the field, the move up may be randomized such that a compressive sensing method maximizes a quality of the final acquired seismic dataset.

Although the above description of an embodiment of the disclosure is discussed with respect to source lines, it should be noted that the randomization techniques described herein may be applied to receiver lines, source lines, or both. Indeed, by way of example, in some embodiments, shot lines may be modified (e.g., move up) to reduce overall acquisition time by applying the randomization techniques to an ocean bottom survey using nodes or cables with source boats deploying sources to cover the area, a marine streamer survey of one or more boats, and the like. In another example, perturbing receiver line move up techniques (e.g., randomization) may be applied to a land survey, a marine survey using streamers or laying ocean bottom equipment, or the like.

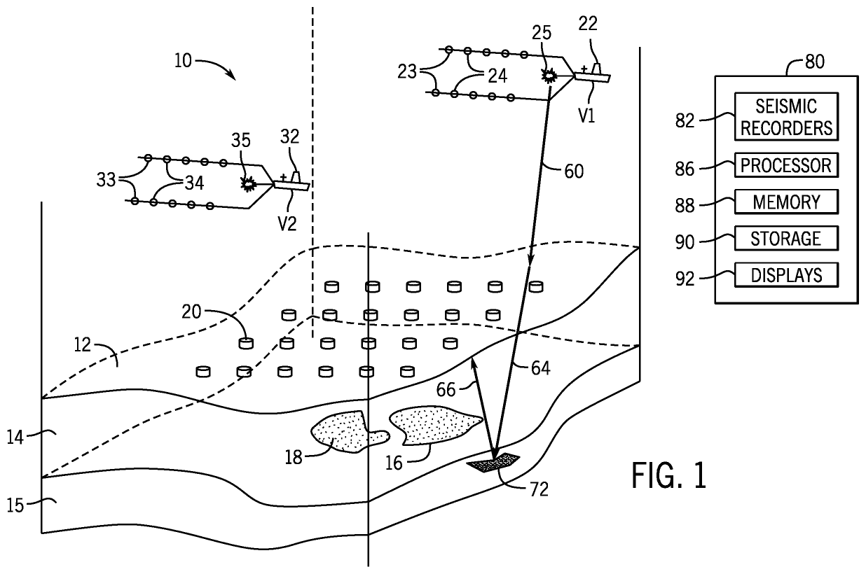

By way of introduction, FIG. 1 is a schematic diagram of a seismic survey using different seismic measurements based on reflection waves. An area may include a surface 10 and a water bottom 12. Multiple subsurface layers (e.g., subsurface layers 14 and 15) may be located beneath the water bottom 12. Geological structures 16 and 18 with complex geometries, such as salt bodies, may be embedded in the subsurface layers. The geological structures 16 and 18 may be within a close proximity to (e.g., on top of) or enclose a geological formation 72 that may contain hydrocarbon deposits. Seismic data acquired in a seismic survey may be used to image the water bottom 12, the subsurface layers 14 and 15, and the geological structures 16 and 18. Images of subterranean geologic structures may provide indications of the hydrocarbon deposits.

The seismic survey may include OBN measurements by employing multiple OBNs 20 on the water bottom 12. The OBNs may be deployed (e.g., using remotely operated vehicles (ROVs)) to selected locations and form a certain geometry (e.g., regular, irregular, or hybrid geometry). Each of the OBNs 20 may include one or more OBN sensors. The OBN sensors may include one or more geophones (e.g., single-component, two-component, three-component geophones), one or more accelerometers (e.g., micro electromechanical system (MEMS) accelerometers), other suitable seismic sensors that are able to measure ground motions. In some embodiments, the OBN sensors may also include hydrophones. For convenience, this written description refers to ocean bottom nodes in many places, but it is within the scope of this disclosure that when reference is made to an OBN, any type of sensor mechanism or sensor placement technique may be used according to the embodiments disclosed herein when referring to an OBN, e.g., ocean bottom cables with incorporated sensors, optical fibers, and any other sensor placement technique or mechanism that places a sensor on the seabed to detect seismic signals. So the reader with skill in the art will recognize that when referring to OBN in this disclosure, any suitable sensor may be used on a seabed. Moreover, while ocean and seabed are used in this disclosure, the bodies of water in which the disclosed techniques may be used encompass any water-based environment one may perform seismic surveys in, e.g., canals, channels, lakes, gulfs, seas, ponds, rivers, streams, fjords, straits, bays, swamps, inlets, and the like. Thus, the reader with skill in the art will recognize that when referring to ocean and/or seabed in this disclosure, any body of water in which a seismic survey may be conducted is within the scope of the embodiments disclosed herein.

One or more seismic source vessels may be used in the seismic survey. For example, a source vessel 22 towing a seismic source 25 and another source vessel 32 towing another seismic source 35 may be used to create seismic waves propagating downward into the subterranean geologic structures. Each of the seismic sources 25 and 35 may include one or more source arrays and each source array may include a certain number of air guns.

The seismic survey may also include streamer measurement by employing multiple streamers traversing the area. For example, the source vessel 22 may tow multiple (e.g., two, four, six, eight, or ten) streamers 23 along one sail line, and the source vessel 32 may tow multiple streamers 33 along another sail line. The streamer measurement may be acquired simultaneously with the OBN measurement using shots fired by the seismic sources 25 and 35. Each streamer may include multiple streamer sensors. For example, each of the streamers 23 may include streamer sensors 24 and each of the streamers 33 may include streamer sensors 34. The streamer sensors 24 and 34 may be single or multicomponent and include hydrophones, geophones, and/or accelerometers that create electrical signals in response to water pressure changes caused by reflected seismic waves that arrive at the hydrophones.

During the seismic survey, the seismic source 25 may be activated to generate seismic waves 60 traveling downward into the subterranean geologic structures. When the seismic waves 60 arrives at the water bottom 12, a portion of seismic energy contained in the seismic waves 60 is reflected by the water bottom 12. Reflected waves travel upward and arrive at different sensors, such as the streamer sensors 24 and 34. Another portion of the seismic energy contained in transmitted seismic waves 64 propagates through the water bottom 12 into the subsurface layer 14. A portion of seismic energy contained in the transmitted waves 64 is reflected by the geological formation 72. Reflected waves 66 travel upward and arrive at the different sensors.

The elements described above with regard to the seismic survey are example elements. For instance, some embodiments of the seismic survey may include additional or fewer elements than those shown. In some embodiments, the seismic survey may include more or less of the source vessels. In some embodiments, separated receiver vessels may be used to tow the streamers while one or more source vessels are used to tow the seismic sources. In some embodiments, the streamer measurement may be acquired independently from the OBN measurement for operational or logistical reasons. In some embodiments, near field hydrophone (NFH) and/or seismic profile (VSP) may be used.

Seismic data simultaneously acquired from different sensors may be collected and processed by a processing system 80. The processing system 80 may include one or more seismic recorders 82, one or more processors 86, a memory 88, a storage 90, and one or more displays 92. The one or more seismic recorders 82 may receive OBN data from OBNs 20, streamer data from streamer sensors 24 and 34, and other seismic data (e.g., NFH data, VSP data). Collected data may be processed by the processor 86 using processor-executable code or instructions stored in the memory 88 and the storage 90. The processed data may be stored in the storage 90 for later usage. The results of the processed data may be displayed via the one or more displays 92.

The processors 86 may include any type of computer processor or microprocessor capable of executing computer-executable code. The processors 86 may include single-threaded processor(s), multi-threaded processor(s), or both. The processors 86 may also include hardware-based processor(s) each including one or more cores. The processors 86 may include general purpose processor(s), special purpose processor(s), or both. The processors 86 may be communicatively coupled to other components (such as one or more seismic recorders 82, interrogator 84, memory 88, storage 90, and one or more displays 92).

The memory 88 and the storage 90 may be any suitable articles of manufacture that can serve as media to store processor-executable code, data, or the like. For example, the memory 88 and the storage 90 may represent non-transitory computer-readable media (e.g., any suitable form of memory or storage) that may store the processor-executable code used by the processor 86 to perform the presently disclosed techniques. It should be noted that non-transitory merely indicates that the media is tangible and not a signal. The memory 88 and the storage 90 may also be used to store data described (e.g., fiber sensor data, geophone data), various other software applications for seismic data analysis and data processing.

The one or more displays 92 may operate to depict visualizations associated with software or executable code being processed by the processor 86. The display 66 may be any suitable type of display, such as a liquid crystal display (LCD), plasma display, or an organic light emitting diode (OLED) display.

The components described above with regard to the processing system 80 are example components and the processing system 80 may include additional or fewer components as shown. For example, the processing system 80 may include one or more communication interfaces to send commands to different seismic acquisition systems and receive measurement from the different seismic acquisition systems.

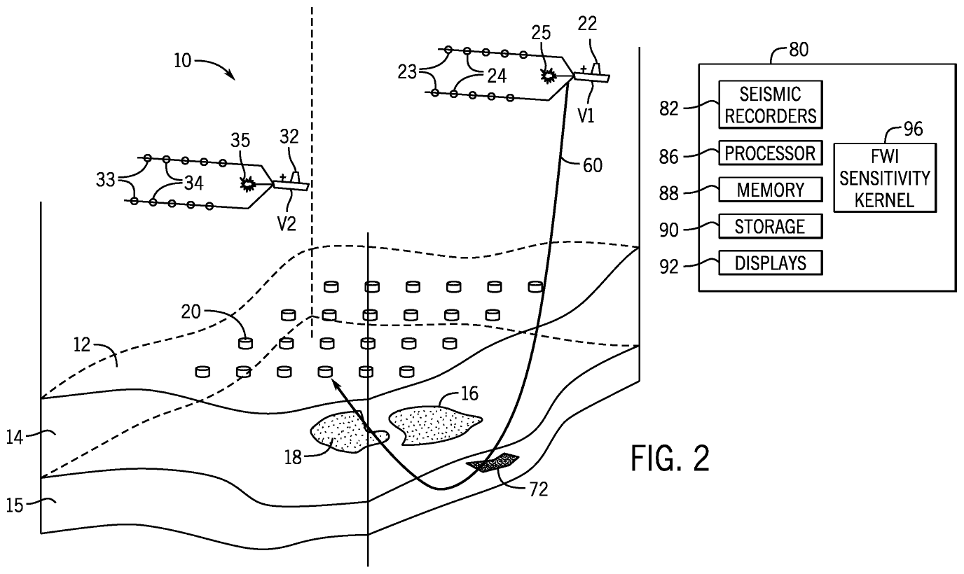

FIG. 2 is a schematic diagram of a seismic survey using different seismic measurements based on diving waves. Certain features and components of illustrated seismic data acquisition may be similar to the seismic data acquisition illustrated in FIG. 1. However, the present embodiment is using the different seismic measurements based on diving waves, instead of the reflection waves. For example, the seismic measurements of FIG. 1 utilize the reflection waves 66, which may be reflected by the geological formation 72 that may contain hydrocarbon deposits, but may not penetrate through the geological structure 18 and reach certain OBNs 20. As such, utilizing the seismic measurements based on the reflection waves may not provide image data regarding subterranean geologic structures that may be indicative of the hydrocarbon deposits associated with the geological formation 72 near the geological structures 16 and 18.

In comparison, the seismic measurements of FIG. 2 utilize the diving waves 100 to provide better penetration towards subterranean geologic structures (e.g., sub-salt structures like geological formation 72), therefore improving the possibility and accuracy of subsurface properties characterization (e.g., subsurface velocity) and as such improved prospecting for hydrocarbon deposits. Diving waves may be referred to as waves that dive into the subsurface and then turn back again (e.g., based on a gradual increase in velocity with depth), without a clear reflection event. The diving waves (e.g., diving waves 100) may dive below the geological structure 16, pass through the geological formation 72, and turn back to penetrate the geological structure 18 and arrive at the OBNs 20 on the water bottom 12. As a result, the diving waves 100 may carry geological information related to the geological formation 72, which may include important information associated with the geological formation 72. In some embodiments, the processing system 80 includes an FWI sensitivity kernel 96 that may be used to validate various combinations of sparse node OBN source and receiver patterns, as well as source design.

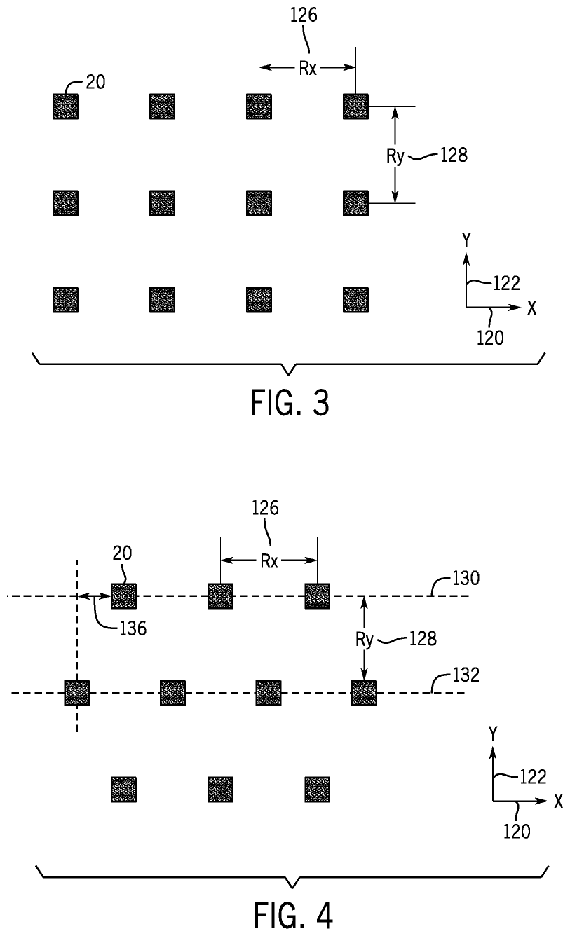

The embodiment of FIG. 2 may utilize different patterns of ocean bottom nodes, such as regular, irregular, or hybrid patterns for OBN data acquisition. Various examples of OBN patterns will be discussed in detail below with reference to FIGS. 3-6.

By way of introduction, OBN surveys, such as a sparse OBN survey, may be complicated and/or expensive to design, plan and execute. For example, a desired sparse OBN patch may cover sufficiently large area with ocean bottom nodes over geological target and may have an extension of sources (e.g., a halo) beyond the nodes for migration and FWI apertures. A desired OBN survey design may be cost-efficient and capable of delivering a sufficient amount of data to fulfill both imaging and FWI requirements. The density of the nodes may be in the regular or irregular pattern, sparse or dense pattern in X and Y (or inline and crossline) directions.

With the forgoing in mind, FIG. 3 is an example of OBN measurement with a regular pattern of nodes that may be employed in the seismic survey of FIG. 2. In certain embodiments, the regular pattern of nodes may be described as an X-Y grid pattern, such that the nodes may be arranged in parallel rows and columns. In other words, the nodes may be aligned with one another in each row in an X direction, and the nodes may be aligned with one another in each column in a Y direction. A coordinate system, including a first direction 120 and a second direction 122 perpendicular to the first direction 120 (referred to as X and Y directions, respectively), is used to describe relative spacings between the OBNs 20 on the water bottom 12. For example, a first spacing 126 and a second spacing 128 (referred to as Rx and Ry) are used to represent the distance between two adjacent OBNs 20 along the X and Y directions. In present example, the Rx and Ry of adjacent OBNs 20 may be fixed value(s) (e.g., 25, 50, 100, or 250 meters). The Rx and Ry may be same or different.

FIG. 4 is an example of OBN measurement with an alternative pattern of nodes that may be employed in the seismic survey of FIG. 2. The Rx and Ry of adjacent OBNs 20 may be fixed values, but certain adjacent OBNs 20, such as nodes deployed along different lines 132 and 134, may have an offset 136 along the X direction, forming the alternative pattern of nodes. For example, the alternative pattern of nodes may be described as a staggered grid pattern, wherein the nodes are staggered relative to one another from one row to another, from one column to another, or a combination thereof. In the illustrated embodiment, the staggered grid pattern has the nodes aligned with one another in each row in an X direction, while the nodes are staggered with one another in a Y direction. For example, the nodes may be equally spaced relative to one another in each row in the X direction, while each successive row of nodes in the Y direction is shifted or staggered in the X direction relative to a previous row of the nodes. In certain embodiments, any staggered arrangement of the nodes may be used for the staggered grid pattern of the nodes.

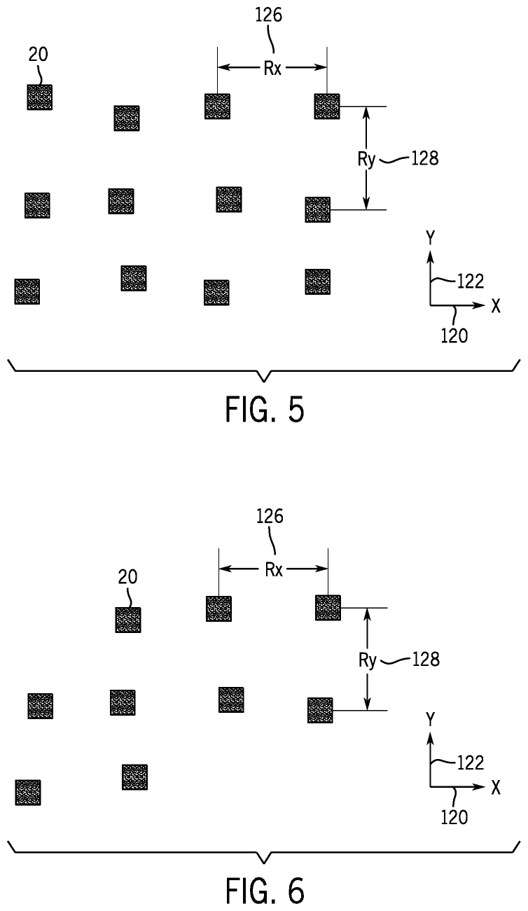

FIG. 5 is an example of OBN measurement with an irregular pattern of nodes that may be employed in the seismic survey of FIG. 2. The irregular pattern of nodes also may be described as an irregular arrangement, group, or distribution of nodes, such that an irregularity (e.g., unequal) or randomness may define the placement of the nodes relative to the X and Y directions. In the illustrated embodiment, the nodes may be misaligned and/or non-uniformly spaced in the X direction, misaligned and/or non-uniformly spaced in the Y direction, or a combination thereof. The nodes may be arranged differently from one row to another, one column to another, or a combination thereof. In some embodiments, the irregular distribution of nodes results in no well-defined rows or columns in the X-Y space. In this example, the Rx and/or Ry of adjacent OBNs 20 may be different values along X and/or Y directions, forming the irregular pattern of nodes.

FIG. 6 is an example of OBN measurement with an irregular pattern of nodes adjusted to subsurface properties that may be employed in the seismic survey of FIG. 2. The irregular pattern of nodes of FIG. 6 may have various characteristics as described above with reference to FIG. 5. However, the boundaries, spacings, and placements of nodes varies between the embodiments of FIGS. 5 and 6. For example, an outline or boundary of the OBN patch may be adjusted to match certain subsurface properties, such as geological constraints, conditions, area of interest, and the like.

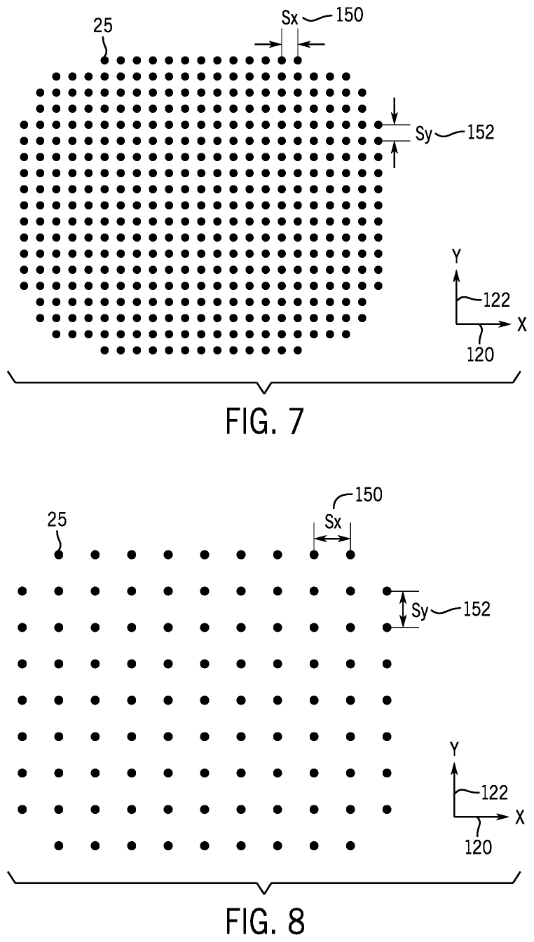

In addition to utilizing different patterns of the ocean bottom nodes as illustrated in FIGS. 3-6, a layout of seismic sources (e.g., seismic source 25 or 35) may also be regular or irregular and may be used in acquisitions over the OBN patch described in the examples described above. In some cases, acquiring more sources than necessary may increase the cost and have an environmental impact. As such, a design of seismic sources, such as the source type and source density may be a relevant part of an OBN survey (e.g., sparse OBN survey). In some embodiments, the OBN survey may include the same source density over an area, or include variable source density (e.g., halo of sparser source coverage outside a node patch). In some embodiments, source type may be standard or specially designed (e.g., using low frequency sources). For example, the seismic sources may include pneumatic sources (e.g., one large air gun or array of air guns), or marine vibrators. Various examples of seismic source patterns will be discussed in detail below with reference to FIGS. 7-10.

FIG. 7 is an example of OBN measurement with a regular pattern of seismic sources that may be employed in the seismic survey of FIG. 2. The coordinate system, including the first direction 120 and the second direction 122 (referred to as X and Y directions, respectively), is used to describe relative spacings between the seismic sources 25 on the water bottom 12. In certain embodiments, the regular pattern of seismic sources may be described as an X-Y grid pattern, such that the seismic sources may be arranged in parallel rows and columns. In other words, the seismic sources may be aligned with one another in each row in an X direction, and the seismic sources may be aligned with one another in each column in a Y direction. For example, a first spacing 150 and a second spacing 152 (referred to as Sx and Sy) are used to represent the distance between two adjacent seismic sources 25 along the X and Y directions. In present example, the Sx and Sy of adjacent seismic sources 25 may be fixed values (e.g., 5, 10, 25, 50 meters). The Sx and Sy may be same or different.

FIG. 8 is an example of OBN measurement with a sparse pattern of seismic sources that may be employed in the seismic survey of FIG. 2. In the illustrated embodiment, the sparse pattern of seismic sources may be a grid pattern as discussed above with reference to FIG. 7; however, the spacing of the seismic sources in FIG. 8 is greater than the spacing of the seismic sources in FIG. 7. The Sx and Sy of adjacent seismic sources 25 may be fixed value(s) greater than the Sx and Sy of FIG. 7, such as at least equal to or greater than 10, 15, 20, or 25 meters, forming the sparse pattern of seismic sources. In certain embodiments, the spacing (e.g., Sx and/or Sy) of seismic sources in FIG. 8 may be at least equal to or greater than 1.5, 2, 2.5, 3, 3.5, 4, 4.5, 5, or 10 times the spacing (e.g., Sx and/or Sy) of seismic sources in FIG. 7.

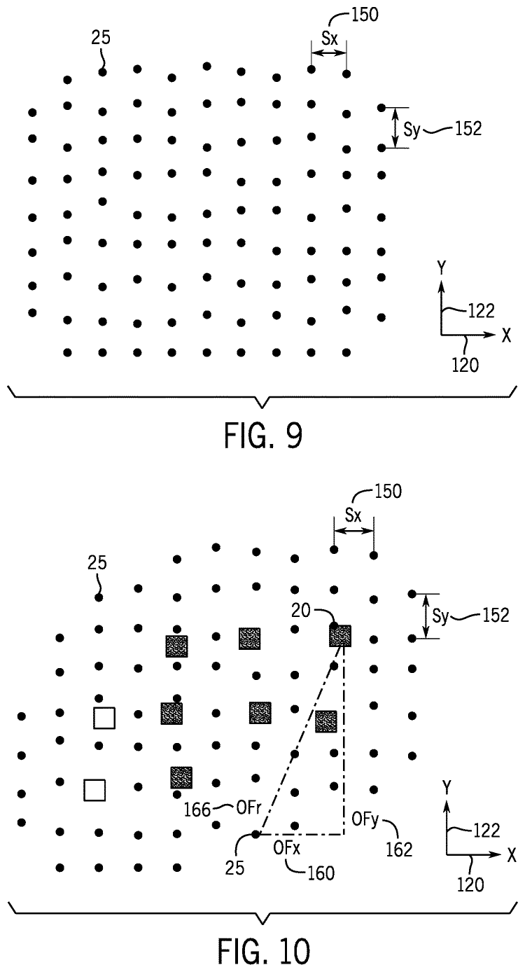

FIG. 9 is an example of OBN measurement with an irregular pattern of seismic sources that may be employed in the seismic survey of FIG. 2. The irregular pattern of seismic sources also may be described as an irregular arrangement, group, or distribution of seismic sources, wherein an irregularity or randomness may define the placement of the seismic sources relative to the X and Y directions. In the illustrated embodiment, the seismic sources may be misaligned and/or non-uniformly spaced in the X direction, misaligned and/or non-uniformly spaced in the Y direction, or a combination thereof. The seismic sources may be arranged differently from one row to another, one column to another, or a combination thereof. In some embodiments, the irregular distribution of seismic sources results in no well-defined rows or columns in the X-Y space. In this example, the Sx and Sy of adjacent seismic sources 25 may be different values along X and/or Y directions, forming the irregular pattern of seismic sources.

FIG. 10 is an example of OBN measurement with an irregular pattern of seismic sources adjusted to subsurface properties that may be employed in the seismic survey of FIG. 2. The irregular pattern of seismic sources of FIG. 10 may have various characteristics as described above with reference to FIG. 9. However, the boundaries, spacings, and placements of seismic sources varies between the embodiments of FIGS. 9 and 10. For example, in the illustrated embodiment of FIG. 10, an outline or boundary of the seismic sources patch may be adjusted to match the subsurface properties, such as geological constraints, conditions, area of interest, and the like. A first offset 160 and a second offset 162 (referred to as OFx and OFy) are used to represent the spacings between an ocean bottom node 20 and a seismic source 25 along the X and Y direction. A third offset 166 (defined as square root of (OFx)²+(OFy)²)) is used to represent the distance between the ocean bottom node 20 and the seismic source 25.

In an OBN survey, a grid of OBNs 20 may be dense or sparse. In a case of sparse node spacing, to correctly sample the diving waves (e.g., diving waves 100), a sampling cannot exceed a ratio of the wavelength λ of the diving waves, which is a function of the earth velocity V, and the frequency F, as described in the following equation:

$$λ = V / F .$$

For example, for a velocity of 3000 meter/s, a low frequency of 1.5 Hz and a sampling with the ratio around 2, the maximum sampling may be of the range 800 meters to 1600 meters.

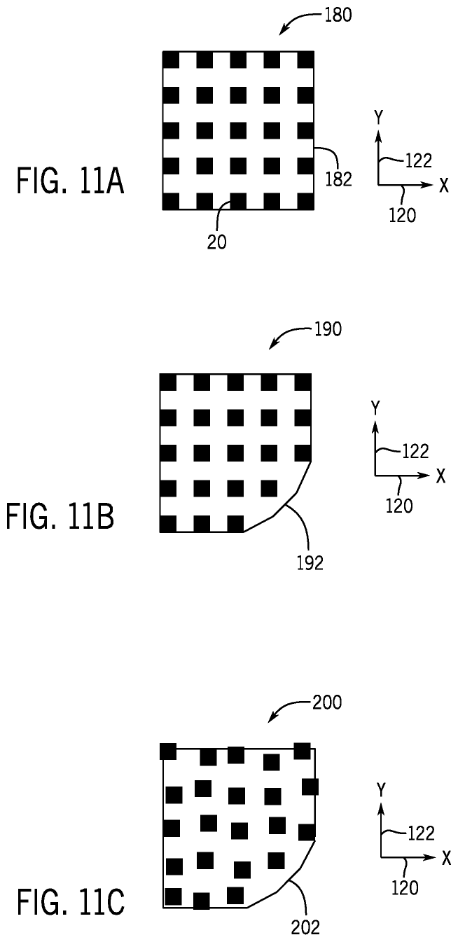

Ocean bottom nodes may be spaced on a regular grid (e.g., rectangular grid), adjusted to a survey area, or on an irregular grid adjusted to the subsurface properties. Density of the ocean bottom nodes may vary based on an objective of the survey and may include a combination of denser and sparser node densities on the regular or irregular grid adjusted to the survey area and subsurface objectives. Various examples of OBN surveys will be discussed in detail below with reference to FIGS. 11-14.

FIGS. 11A, 11B, and 11C are examples of OBN surveys having different node designs that may be employed in the seismic survey of FIG. 2. A first node patch 180 includes the OBNs 20 spaced on a rectangular grid 182. The first node patch 180 may have various characteristics as discussed above with reference to FIG. 3. A second node patch 190 includes the OBNs 20 that are adjusted to a node area 192. The second node patch 190 may be substantially the same as the first node patch 180, wherein a portion of the nodes are removed at the node area 192. A third node patch 200 includes the OBNs 20 spaced on an irregular grid 202 adjusted to certain subsurface properties (e.g., geological constraints, conditions, area of interest, and the like). The third node patch 200 may have various characteristics as discussed above with reference to FIGS. 5 and 6.

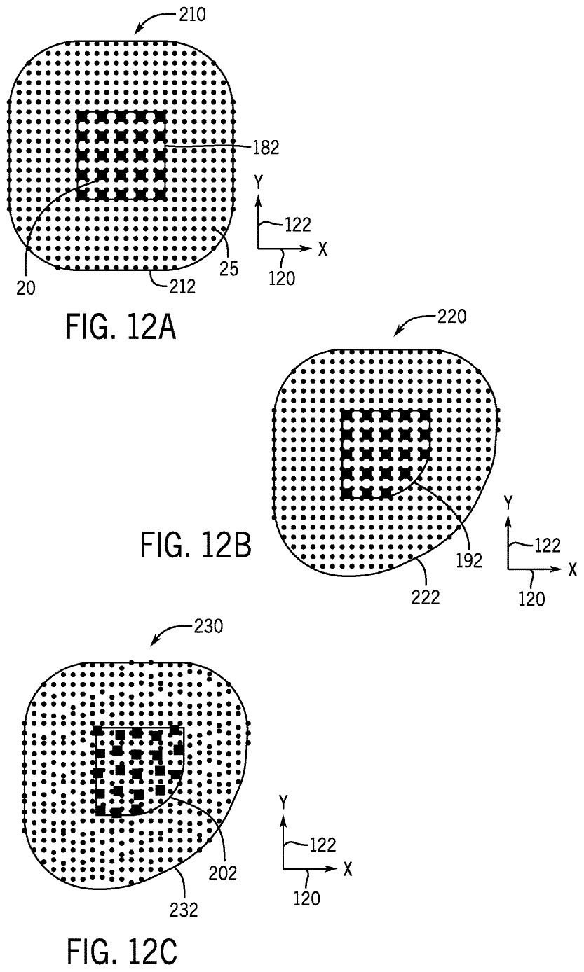

The density of the ocean bottom nodes may vary based on the objective of the survey. FIGS. 12A, 12B, and 12C are examples of OBN surveys having different dense node designs that may be employed in the seismic survey of FIG. 2. A first OBN survey 210 includes the OBNs 20 spaced on the rectangular grid 182 with dense node spacing as discussed above with reference to FIG. 11A, and the seismic sources 25 spaced on a regular grid 212. A second OBN survey 220 includes the OBNs 20 adjusted to the node area 192 with dense node spacing as discussed above with reference to FIG. 11B, and the seismic sources 25 spaced on a source area 222 that is adjusted accordingly with respect to the node area 192. A third OBN survey 230 includes the OBNs 20 spaced on the irregular grid 202 adjusted to the subsurface properties as discussed above with reference to FIG. 11C, and the seismic sources 25 spaced on a source area 232 that is adjusted accordingly with respect to the irregular grid 202. The third OBN survey 230 may include irregular pattern of seismic sources 25 adjusted to the subsurface properties.

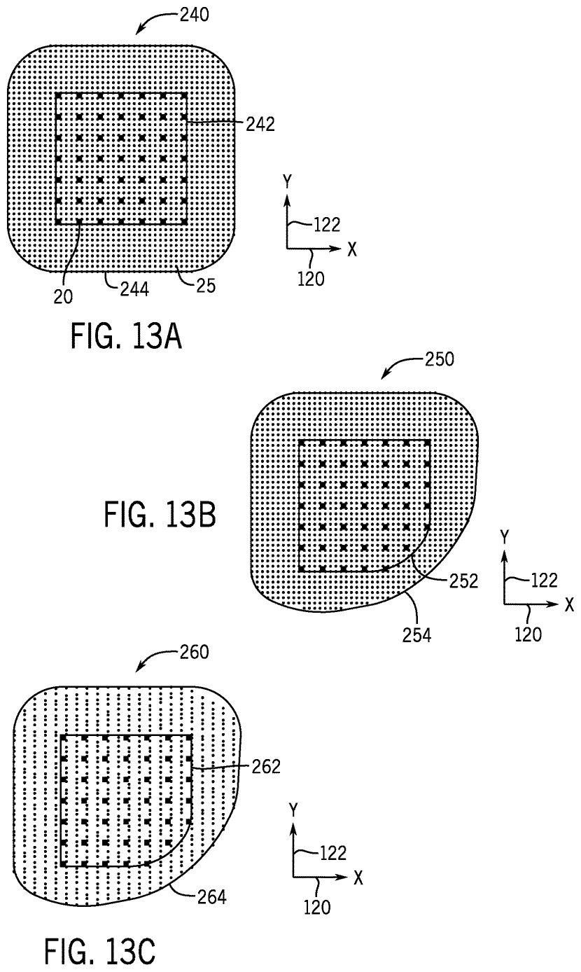

FIGS. 13A, 13B, and 13C are examples of OBN surveys having different sparse node designs that may be employed in the seismic survey of FIG. 2. A first sparse OBN survey 240 includes the OBNs 20 spaced on a sparse rectangular grid 242 with sparse node spacing, and the seismic sources 25 spaced on a regular source grid 244. The OBNs 20 of FIG. 13A are arranged similar to the OBNs 20 of FIGS. 11A and 12A, wherein the OBNs 20 of FIG. 13A are spaced further apart from one another than the OBNs of FIGS. 11A and 12A. A second sparse OBN survey 250 includes the OBNs 20 adjusted to a node area 252 with sparse node spacing (e.g., substantially the same as FIG. 13A with the adjustment in the node area 252), and the seismic sources 25 spaced on a source area 254 that is adjusted accordingly with respect to the node area 252. The OBNs 20 of FIG. 13B are arranged similar to the OBNs 20 of FIGS. 11B and 12B, wherein the OBNs 20 of FIG. 13B are spaced further apart from one another than the OBNs of FIGS. 11B and 12B. A third sparse OBN survey 260 includes the OBNs 20 spaced on a regular grid 262 adjusted to the subsurface properties (e.g., substantially the same as FIG. 13B), and the seismic sources 25 spaced on a source area 264 that is adjusted accordingly with respect to the irregular grid 262. The third sparse OBN survey 260 may include irregular pattern of seismic sources 25 adjusted to the subsurface properties.

In some embodiments of sparse OBN survey, the OBNs 20 may be spaced apart from one another by distances between 800 meters to 1600 meters. In some embodiments, the OBNs 20 may be spaced apart from one another by other distance ranges, such as 400 meters to 3000 meters, 500 meters to 2500 meters, 600 meters to 2000 meters, 700 meters to 1800 meters, or 600 meters to 1600 meters.

In some embodiments, the grid of seismic sources 25 may be dense to improve the signal to noise (S/N) ratio of recorded seismic data, such as the examples of OBN surveys described in FIGS. 12 and 13. As such, seismic sources 25 may be separated by a smaller fraction of the wavelength (e.g., 50 meters, 100 meters, or any other suitable intervals). In some embodiments, multiple seismic sources towed by a vessel may be separated by a desired distance and fired in a distance or time mode at a desired rate, which may ultimately produce a regular or irregular grid of sources.

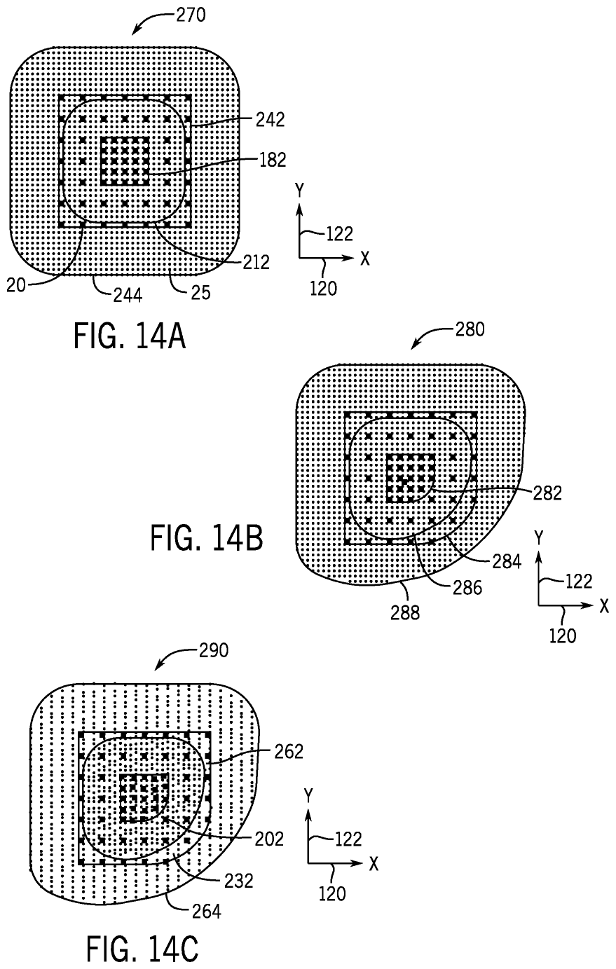

In some cases, an OBN survey may include a combination of dense and sparse node densities on the regular or irregular grid adjusted to the survey and subsurface objectives. FIGS. 14A, 14B, and 14C are examples of OBN surveys having different hybrid node designs that may be employed in the seismic survey of FIG. 2. For example, a first hybrid OBN survey 270 includes the OBNs 20 spaced on the rectangular grid 182 with dense node spacing and the sparse rectangular grid 242 with sparse node spacing, and the seismic sources 25 spaced on the regular source grids 212 and 244. A second hybrid OBN survey 258 includes the OBNs 20 adjusted to an internal node area 282 with dense node spacing and an external node area 284 with sparse node spacing, and the seismic sources 25 spaced on an internal source area 286 and an external source area 288 that are adjusted accordingly with respect to the internal node area 282 and external node area 284, respectively. A third hybrid OBN survey 290 includes the OBNs 20 spaced on the irregular grid 202 and the regular grid 262 adjusted to the subsurface properties, and the seismic sources 25 spaced on the source area 232 and the source area 264 that are adjusted accordingly with respect to the irregular grid 202 and the regular grid 262, respectively. The third hybrid OBN survey 290 may include an irregular pattern of seismic sources 25 adjusted to the subsurface properties.

To improve the efficiency of the seismic source effort, in some embodiments, the number of source vessels, the number of sources per vessel, the separation between sources, the speed of the source vessel, or any combination thereof, may be increased. In some embodiments, simultaneous shooting, modification of the source firing scheme, and overall source grid separation may vary along the OBN survey (e.g., the third hybrid OBN survey 290). For example, different pneumatic sources activated with time delays may be used to improve efficiency and illumination of the subsurface formations. The designed time delays may be in a range from zero to a duration that may extend beyond the maximum reflection time from the deepest event of interest.

To improve the frequency content, in some embodiments, a mixing of different types of seismic sources towed by the same or by different vessels and fired simultaneously or independently may be used in the OBN survey. In some embodiments, an implementation using low frequency sources may compensate some sparsity in the source or even receiver grid. In some embodiments, ocean bottom data may be acquired for an FWI analysis with the low frequency sources, wherein a source line interval between multiple source lines is at least equal to or greater than 600 meters.

The spatial extent of seismic sources around the grid of ocean bottom nodes may be driven by offsets (e.g., distance between a source and a node) based diving wave penetrations. For instance, a depth of diving wave penetration may be equal to around one third of the maximum source to receiver offset and may be equal to or greater than 50 kilometers.

FWI may be applied to various data collection and processing systems, especially with the previously described methodology. The power of FWI may depend on several components, including but not limited to the low-frequency content of observed data, the length of the maximum offset, and the azimuthal distribution of the offsets. Long offset and full azimuthal data may be obtained by a nodal acquisition, which is, by default, full azimuthal all the way up to the design nominal offset (e.g., equal to or greater than 50 kilometers). The low-frequency content of the data may be related to the source type. In certain embodiments, ultra-low frequency sources may be used to produce frequencies down to 0.1 Hz, or down to 0.3 Hz, or down to 0.5 Hz, or down to 1 Hz, or down to 1.5. In certain embodiments, the low-frequency sources may contain frequencies up to 30 Hz, or up to 40 Hz, or up to 100 Hz. Although certain specific values (e.g., 10-, 15-, 20-, or 25-meters source spacing, 25-, 50-, 100-, or 250-meters node spacing) are used to describe disclosed embodiments, they should be understood as approximate values and may be more or less than 5-10% of the listed values.

With the foregoing seismic arrangements in mind, in some embodiments, during a seismic acquisition, seismic acquisition equipment may advance to different source lines in a regular or periodic movement to provide continuous and regular coverage. However, in some embodiments, an irregular movement to different source lines and sources may also be designed to provide irregular coverage (e.g., increase or decrease the distance that the next source line is shifted). The irregular movement may be used to accelerate progress to cover the area of interest. That is, for the irregular movement, a complete coverage for the area of interest with regular distances between source lines may be obtained via interpolation of the seismic data acquired via the irregular movement. As used herein, the irregular movement may use random distances to shift source lines, such that a compressive sensing method may be used to maximize the quality of the final dataset. The irregularity in the final dataset may be handled or processed by a number of algorithms including FWI, and many migrations of the irregularity may be handled internally in the algorithms, which may not involve further preprocessing work. As a result, the processed seismic datasets may correspond to seismic datasets acquired via regular movements.

Before continuing further, it should be noted that various embodiments disclosed herein may be applied to both receiver lines and source lines. For example, increasing shot line move up (e.g., distance between source lines) may be used to reduce overall time of the survey, such as the OBN seismic survey of FIG. 1 or FIG. 2. Moreover, perturbing receiver line move up may also be applied to a land survey, or a marine survey using streamers, or laying ocean bottom equipment. In all these examples, one or more pieces of equipment may be used to manage the lines of receivers or sources.

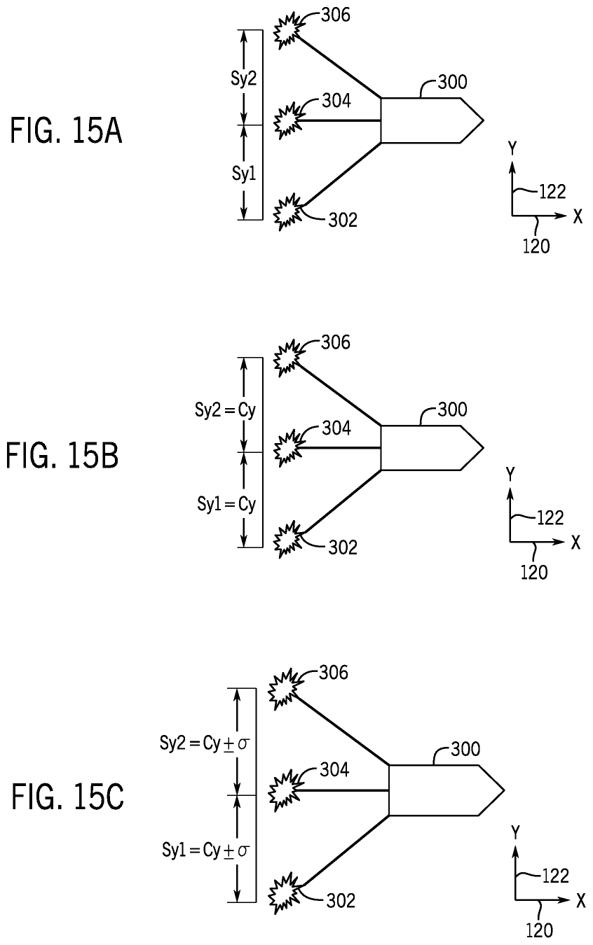

With this in mind, FIGS. 15A, 15B, and 15C are examples of source lines accompanying a source boat 300 that may be employed in the OBN seismic survey of FIG. 1 or FIG. 2. The source boat 300 may include three sources, 302, 304, and 306 in the XY plane. The spacing between the sources 302 and 304 along Y direction is Sy1, and the spacing between the sources 304 and 306 along Y direction is Sy2, as illustrated in FIG. 15A. FIG. 15B shows an example of sources generated by the source boat 300 that may be used to generate regular pattern of seismic sources. In FIG. 15B, the three sources 302, 304, and 306 have the same spacing along Y direction (e.g., Sy1=Sy2=Cy, Cy is a constant value of length such as 100 meters), and the spacing Sy1 and Sy2 may be fixed throughout the OBN seismic survey to generate regular pattern of seismic sources. FIG. 15C shows an example of sources generated by the source boat 300 that may be used to generate irregular pattern of seismic sources. In FIG. 15C, the three sources 302, 304, and 306 may have random spacing along Y direction), and the spacing Sy1 and Sy2 may be fixed throughout the OBN seismic survey to generate irregular pattern of seismic sources. For example, a random perturbation σ may be applied to the spacing Sy1 and/or the spacing Sy2 in FIG. 15B so that Sy1 and Sy2 may have random values (e.g., Sy1=Cy±σ, Sy2=Cy±σ, Cy is a constant value of length such as 100 meters, and the perturbation σ may have any random value). Accordingly, the three sources 302, 304, and 306 in FIG. 15C may be used to generate irregular pattern of seismic sources.

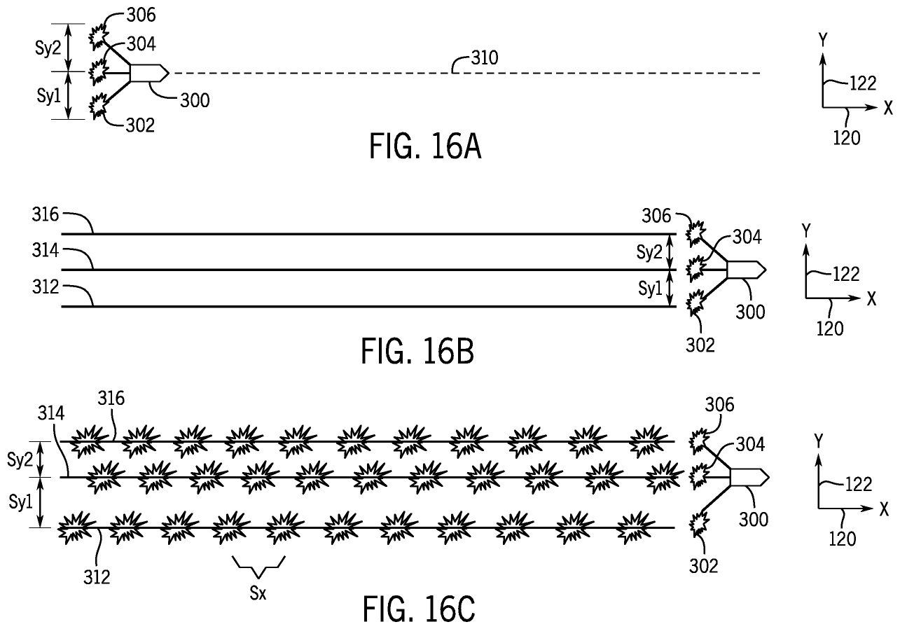

FIGS. 16A, 16B, and 16C are examples of sail lines and seismic source lines configurations for the source boat 300. FIG. 16A illustrates a sail line 310 for the source boat 300 having three sources 302, 304, and 306. As described above, the spacing Sy1 and the spacing Sy2 may have the same value or random values. FIG. 16B illustrates an example of three source lines 312, 314, and 316 generated by the three sources 302, 304, and 306, respectively, with a regular spacing (e.g., Sy1=Sy2). FIG. 16C illustrates an example of the three source lines 312, 314, and 316 with the spacing Sy1 and the spacing Sy2 having random values (e.g., Sy1≠Sy2). In addition, the source intervals along the source lines may be fixed (e.g., the Sx may be the same for sources along the source lines 314 and 316) or irregular (e.g., the Sx may be random values for sources along the source line 312).

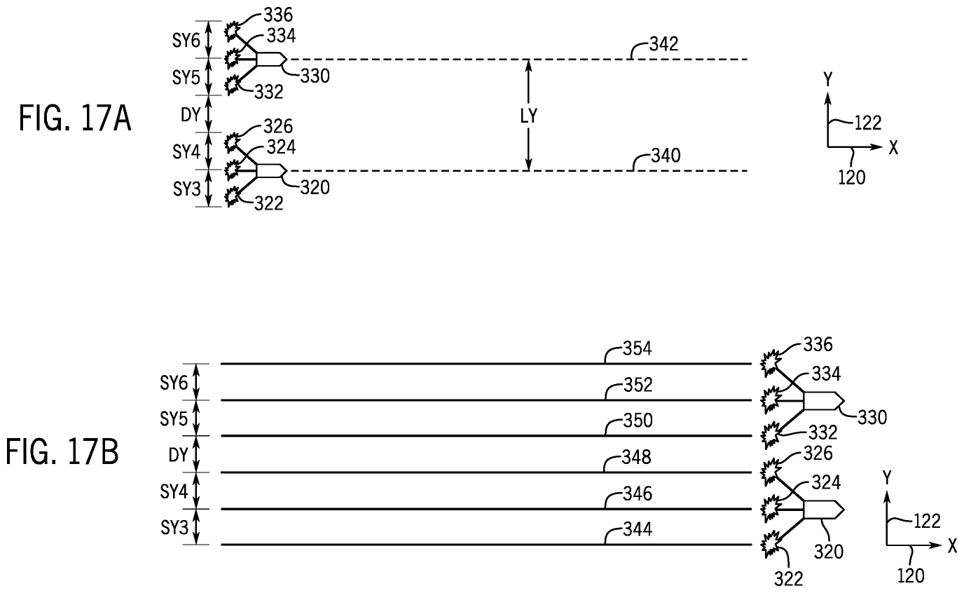

FIGS. 17A and 17B are examples of sail lines and seismic source lines configurations for two sail lines. FIG. 17A shows an example of two source boats 320 and 330 traveling along a sail line 340 and a sail line 342, respectively. The sail line separation between the two sail lines 340 and 342 has a value of Ly. The source boat 320 may include three sources, 322, 324, and 326, with a spacing Sy3 between the source 322 and the source 324 and a spacing Sy4 between the source 324 and the source 326. The source boat 320 may include three sources, 322, 324, and 326, with a spacing Sy3 between the source 322 and the source 324 and a spacing Sy4 between the source 324 and the source 326. In some embodiments (e.g., when the sources 324 and 334 are generated along corresponding sail lines 340 and 342, respectively), the sail line separation Ly may be a summation of the spacings Sy4, Sy5, and Dy, which is a spacing between the source 326 and the source 332.

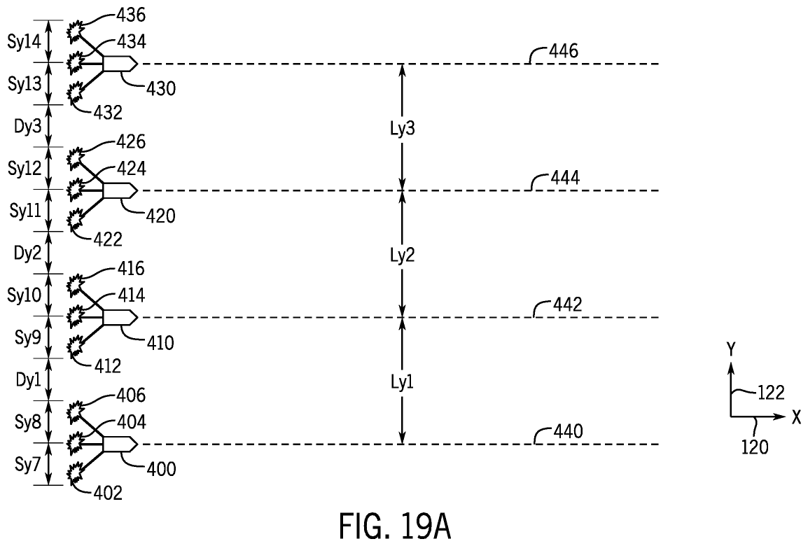

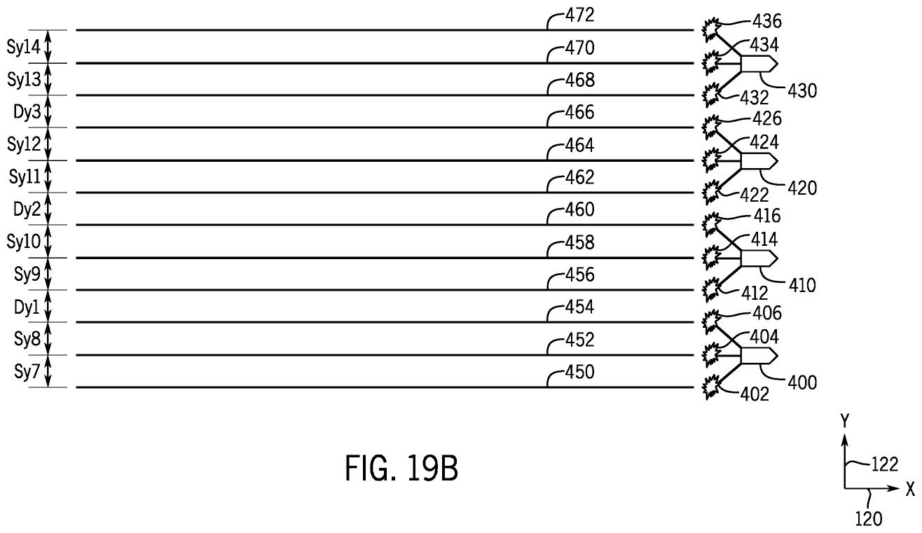

FIG. 17B shows an example of six source lines 344, 346, 348, 350, 352, and 354 that are generated by the six sources 322, 324, 326, 332, 334, 312, 314, and 316, respectively. The spacings Sy3, Sy4, Dy, Sy5, and Sy6 may have the same value or random values, accordingly, each of the source lines 344, 346, 348, 350, 352, and 354 may be separated from its adjacent source lines with a regular spacing or an irregular spacing (e.g., a random value). For example, when the spacings Sy3, Sy4, Dy, Sy5, and Sy6 have the same value (e.g., Sy3=Sy4=Sy5=Sy6=Dy=100 meters), the sail line separation Ly may be 3 times the spacing between the source lines (e.g., 300 meters). An example of four sail lines with regular spacing (e.g., Sy3=Sy4=Sy5=Sy6=100 meters) is illustrated in FIG. 19A and FIG. 19B. In addition, similar as in FIG. 16C, the source intervals along the source lines may be fixed or irregular along the source lines 344, 346, 348, 350, 352, and 354.

In FIG. 17A and FIG. 17B, the six sources and corresponding source lines may be generated by two source boats (e.g., the source boats 320 and 330) simultaneously, or by one source boat (e.g., the source boat 320) moving up along the Y direction. For example, the one source boat (e.g., the source boat 320) may move along the sail line 340 at during a first time period, and then move along the sail line 342 during another time period, and continue to cover the entire survey area. Note that, in practice, the direction of sail lines may vary as the source boats return from the side of the survey they have sailed to. For example, in the scenario that the source lines (e.g., 344, 346, 348, 350, 352, and 354) are generated by one source boat (e.g., the source boat 320), the one source boat may move along the sail line 340 along X direction and then return and move along the sail line 342 along the negative X direction. There are many variations on the details of the boat path in order to achieve this regular coverage which are not described here.

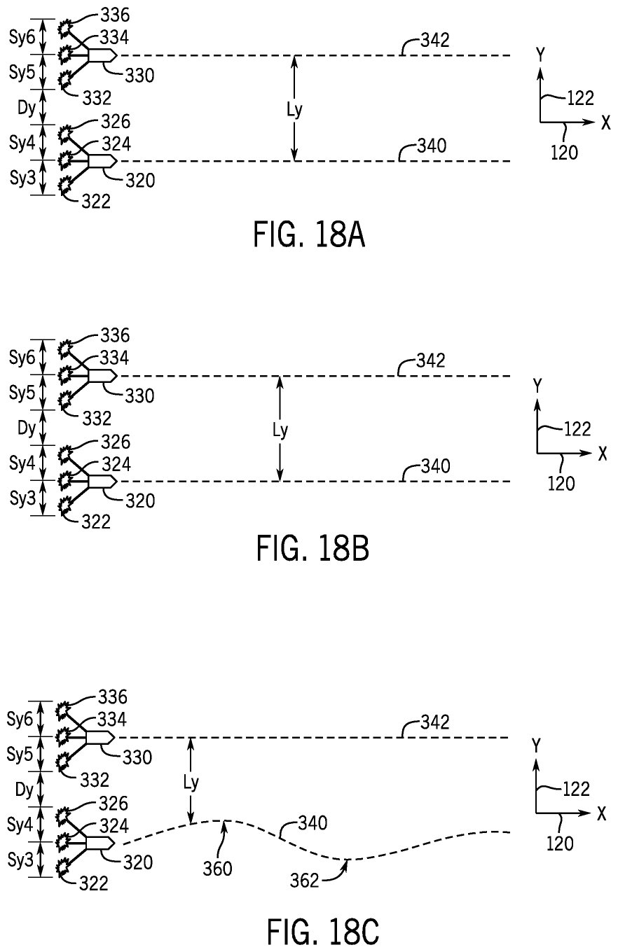

In some embodiments, irregular sail line separations Ly may be used to improve the efficiency of the seismic survey (e.g., increase the amount of area covered in a given time), as illustrated in FIGS. 18A, 18B, and 18C. For simplicity, assume the spacings Sy3, Sy4, Sy5, and Sy6 have the same value (e.g., Sy3=Sy4=Sy5=Sy6=100 meters). FIG. 18A illustrates an example when the sail line separation Ly is greater than three times the spacing between the source lines (e.g., Ly=330±σ meters, the perturbation σ may have any random number in the range of 0 to 15 meters in FIG. 18A). For example, the sail line separation Ly may be increased from a value of 300 meters (e.g., when Sy3=Sy4=Sy5=Sy6=Dy=100 meters) to an average of 330 m but with random variations, which means a sail line may lay anywhere with the sail line separation Ly in the range 315 to 345 meters. Since the sail line separation Ly is greater than three times the spacing between the source lines, the amount of area covered by the source boats in a given time is greater than when the sail line separation Ly is equal to three times the spacing between the source lines (e.g., Ly=300 meters). For example, when Ly has an average value of 330 meters and Ly=330±σ meters (0≤σ≤15 meters), the average increase in the sail line separation Ly may result in about 10% greater coverage of area covered by the source boats in a given time than when use Ly=300 meters, which may result in about 9% reduction in time to cover a given area.

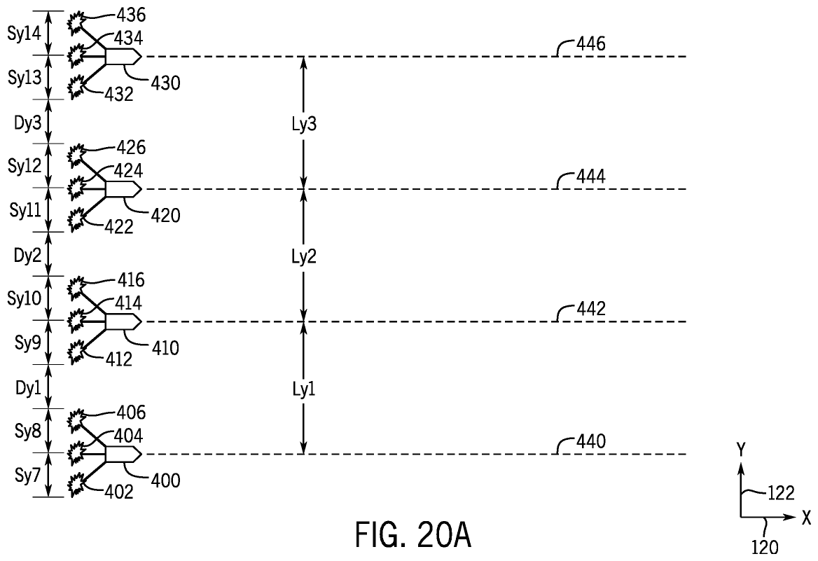

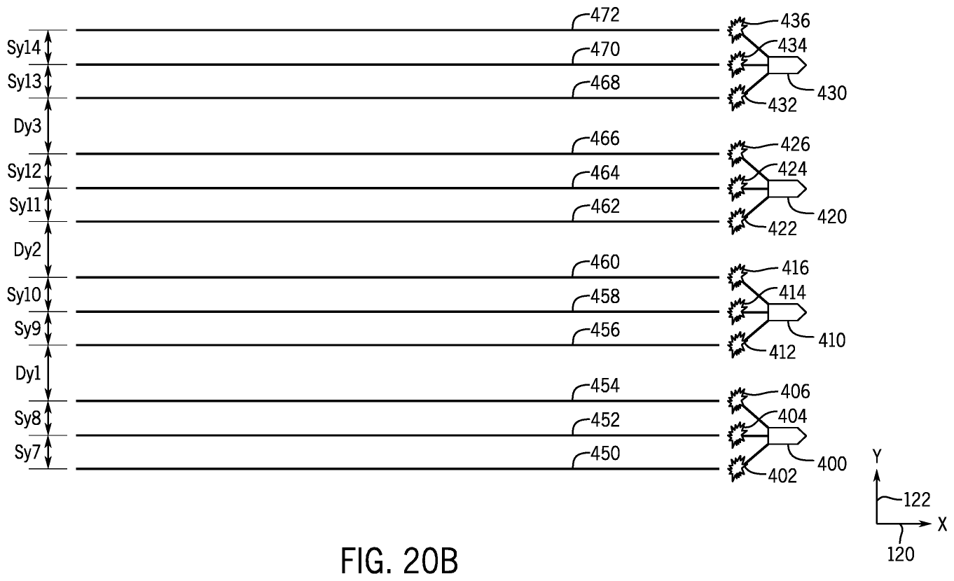

FIG. 18B illustrates another example when the sail line separation Ly is further greater than three times the spacing between the source lines (e.g., Ly=390±σ meters, the perturbation σ may have any random number in the range of 0 to 60 meters in FIG. 18B). For example, the sail line separation Ly may be increased from a value of 300 meters (e.g., when Sy3=Sy4=Sy5=Sy6=Dy=100 meters) to an average of 390 m but with random variations, which means a sail line may lay anywhere with the sail line separation Ly in the range 330 to 450 meters. Since the sail line separation Ly is further greater than three times the spacing between the source lines, the amount of area covered by the source boats in a given time is even greater than when the sail line separation Ly is equal to three times the spacing between the source lines (e.g., Ly=300 meters). For example, when Ly has an average value of 390 meters and Ly=390±σ meters (0≤σ≤60 meters), the average increase in the sail line separation Ly may result in about 30% greater coverage of area covered by the source boats in a given time than when use Ly=300 meters, which may result in about 23% reduction in time to cover a given area. An example of four sail lines with sail line separation Ly greater than three times the spacing between the source lines (e.g., Ly=390±σ meters, the perturbation σ may have any random number in the range of 0 to 60 meters) is illustrated in FIG. 20A and FIG. 20B.

Additionally, the sail line itself may be navigated to introduce variation within the desired range as illustrated in FIG. 18C. FIG. 18C illustrates an example when the sail line separation Ly varies along the sail line (e.g., Ly=390±σ meters, the perturbation σ may have any random number in the range of 0 to 60 meters), which may introduce an additional mitigation of aliases. For example, the sail line separation Ly at location 360 along the sail line 340 may has a different value than at a location 362 along the sail line 340. In some embodiments, the perturbation σ may be an incremental sail line move up amount, which may be a random or pseudo-random number provided by an algorithm. In some embodiments, the perturbation σ may be selected from a predefined sequence so that the sail line separation Ly of the sail lines is larger than the original (or first) value. For example, in FIG. 18C, the original sail line separation may be 300 meters when the source boats 320 and 330 start to travel, and the sail line separation Ly may vary and have a value of (300+σ) meters during the source boats 320 and 330 traveling along the sail lines 340 and 342, respectively. The value of σ may be selected from a varying sequence of distances, such as 300 meters, 190 meters, 250 meters, 290 meters, 380 meters, etc., such that the sail line separation Ly (e.g., 600, 490, 550, 590, 680 meters) on subsequent parts of the sail lines 340 and 342 may continue to be larger than the original (or first) sail line separation 300 meters and, at the same time, have different values between different subsequent parts on the sail lines 340 and 342. Accordingly, in the embodiments described above, the sail line separations Ly of the sail lines may have irregular values (e.g., have different values for at least a part of the total sail lines covered in a seismic survey). For example, when Ly has an average value of 390 meters and Ly=390±σ meters (0≤σ≤60 meters) along the sail lines 340 and 342, the average increase in the sail line separation Ly may result in about 30% greater coverage of area covered by the source boats in a given time than when use Ly=300 meters, which may result in about 23% reduction in time to cover a given area.

In FIGS. 18A, 18B, and 18C, the six sources and corresponding source lines may be generated by two source boats (e.g., the source boats 320 and 330) simultaneously, or by one source boat (e.g., the source boat 320) moving up along the Y direction. For example, the one source boat (e.g., the source boat 320) may move along the sail line 340 at during a first time period, and then move along the sail line 342 during another time period, and continue to cover the entire survey area. Note that, in practice, the direction of sail lines may vary as the source boats return from the side of the survey they have sailed to. For example, in the scenario that the source lines are generated by one source boat (e.g., the source boat 320), the one source boat may move along the sail line 340 along X direction and then return and move along the sail line 342 along the negative X direction. There are many variations on the details of the boat path in order to achieve this regular coverage which are not described here.

FIG. 19A and FIG. 19B illustrate an example of four source boats travelling along four sail lines with regular source line spacing and regular sail line separations. FIG. 19A shows an example of four source boats 400, 410, 420, and 430 traveling along a sail line 440, a sail line 442, a sail line 444, and a sail line 446, respectively. The sail line separations, Ly1 between the sail lines 440 and 442, Ly2 between the sail lines 442 and 444, and Ly3 between the sail lines 444 and 446, have a same value (e.g., 300 meters), which is equal to three times the spacing of the source lines (e.g., 100 meters). The source boat 400 may generate three sources, 402, 404, and 406, with a spacing Sy7 between the source 402 and the source 404 and a spacing Sy8 between the source 404 and the source 406. The source boat 410 may include three sources, 412, 414, and 416, with a spacing Sy9 between the source 412 and the source 414 and a spacing Sy10 between the source 414 and the source 416. The source boat 420 may generate three sources, 422, 424, and 426, with a spacing Sy11 between the source 422 and the source 424 and a spacing Sy12 between the source 424 and the source 426. The source boat 430 may generate three sources, 432, 444, and 436, with a spacing Sy13 between the source 432 and the source 434 and a spacing Sy14 between the source 434 and the source 436. Dy1 is a spacing between the source 406 and the source 412, Dy2 is a spacing between the source 416 and the source 422, and Dy3 is a spacing between the source 426 and the source 432. In some embodiments, the spacing between the sources is a fixed value (e.g., Sy7=Sy8=Sy9=Sy9=Sy10=Sy11=Sy12=Sy13=Sy14=Dy1=Dy2=Dy3=100 meters), and the sail line separations Ly1, Ly2, and Ly3 may be three times the spacing between the source lines (e.g., 300 meters).

FIG. 19B shows an example of twelve source lines 450, 452, 454, 456, 458, 460, 462, 464, 466, 468, 470, and 472 that are generated by the twelve sources 402, 404, 406, 412, 414, 416, 422, 424, 426, 432, 434, and 436, respectively. In FIG. 19B, the spacings of all sources have a fixed value (e.g., Sy7=Sy8=Sy9=Sy9=Sy10=Sy11=Sy12=Sy13=Sy14=Dy1=Dy2=Dy3=100 meters), and the spacing between the source lines is also the same fixed value (e.g., 100 meters) for the twelve source lines. In FIG. 19A and FIG. 19B, the twelve sources and corresponding source lines may be generated by four source boats (e.g., the source boats 400, 410, 420, and 430) simultaneously, or by one source boat (e.g., the source boat 400) moving along the Y direction. For example, the one source boat (e.g., the source boat 400) may move along the sail line 440 during a first time period, and then move along the sail line 442 during another time period, and continue to cover the sail line 444 and 446 until the entire survey area is covered. Note that, in practice, the direction of sail lines may vary as the source boats return from the side of the survey they have sailed to. For example, in the scenario that the source lines are generated by one source boat (e.g., the source boat 400), the one source boat may move along the sail line 440 along X direction and then return and move along the sail line 442 along the negative X direction. There are many variations on the details of the boat path in order to achieve this regular coverage which are not described here.

FIG. 20A and FIG. 20B illustrate an example of the fours source boats in FIGS. 19A and 19B travelling along four sail lines with irregular sail line separations. FIG. 20A shows an example of the four source boats 400, 410, 420, and 430 traveling along the sail lines 440, 442, 444, and 446, respectively, with irregular sail line separations. The sail line separations, Ly1 between the sail lines 440 and 442, Ly2 between the sail lines 442 and 444, and Ly3 between the sail lines 444 and 446, have random values (e.g., 390±σ meters, the perturbation σ may have any random number in the range of 0 to 60 meters). For example, the sail line separation Ly1 may have a value of 420 meters, the sail line separation Ly2 may have a value of 360 meters, and the sail line separation Ly3 may have a value of 400 meters. FIG. 20B shows an example of twelve source lines with irregular sail line separations. For example, the spacing Dy1 between the source 406 and the source 412 may have a value of 220 meters, the spacing Dy2 between the source 416 and the source 422 may have a value of 160 meters, and the spacing Dy3 between the source 426 and the source 432 may have a value of 200 meters. In FIG. 20B, the spacing between sources of the same boat may have a fixed value (e.g., Sy7=Sy8=Sy9=Sy9=Sy10=Sy11=Sy12=Sy13=Sy14=100 meters). Accordingly, due to the irregularity in the sail line separations, the twelve source lines in FIG. 20B may have irregular spacings. In some embodiments, the spacing between sources of the same boat may have a random value.

In FIG. 20A and FIG. 20B, the twelve sources and corresponding source lines may be generated by four source boats (e.g., the source boats 400, 410, 420, and 430) simultaneously, or by one source boat (e.g., the source boat 400) moving along the Y direction, as described above in FIG. 19A and FIG. 19B. For example, the one source boat (e.g., the source boat 400) may move along the sail line 440 during a first time period, and then move along the sail line 442 during another time period, and continue to cover the sail line 444 and 446 until the entire survey area is covered. Note that, in practice, the direction of sail lines may vary as the source boats return from the side of the survey they have sailed to. For example, in the scenario that the source lines are generated by one source boat (e.g., the source boat 400), the one source boat may move along the sail line 440 along X direction and then return and move along the sail line 442 along the negative X direction. There are many variations on the details of the boat path in order to achieve this regular coverage which are not described here.

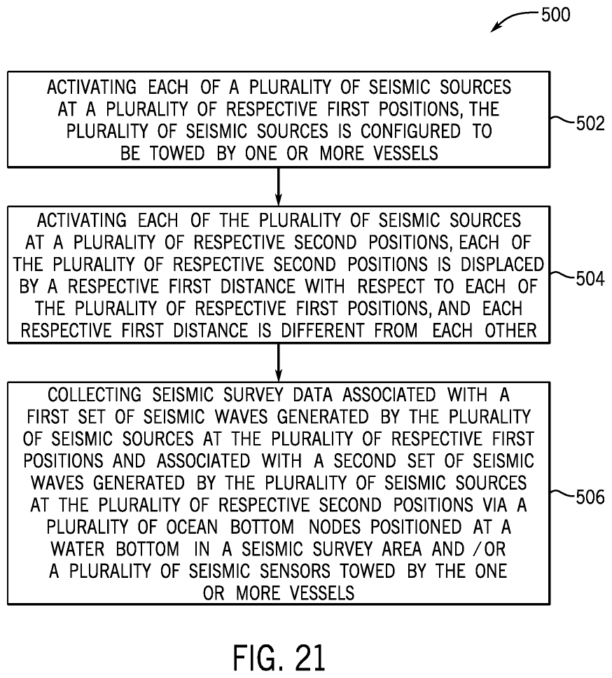

FIG. 21 is a flow diagram of a process 500 for conducting seismic surveys in accordance with any of the embodiments or combination of the embodiments described above. Although the method described in FIG. 21 is described in a particular order and as being performed by a particular component, it should be understood that the method may be performed in any suitable order and by any suitable set of survey system components, computing devices, and/or applications.

Referring now to FIG. 21, multiple ocean bottom nodes, each including one or more sensors, may be deployed at a water bottom in a seismic survey, the plurality of ocean bottom nodes may be spaced at regular or irregular intervals. At block 502, multiple seismic sources including different types of seismic sources towed by the same or different vessels may be activated, such that they are fired simultaneously or independently at corresponding first positions designed to have desired sampling of wavefields including reflection and diving waves. At block 504, the multiple seismic sources may be located at corresponding second positions displaced by corresponding first distances to the first positions, and each of the first distances may be different from each other (or one or more of the first distances may be different from each other). The multiple seismic sources may be activated at block 504. It should be noted, that the first and second positions may correspond to the embodiments described above with reference to FIG. 16C. The sail lines of the towed seismic sources may be displaced with respect to each other as described above with reference to FIGS. 16B-20B. The sources may be activated at different times as described above with reference to FIG. 16C.

At block 506, the processor 86 of the processing system 80 may record the seismic wavefields generated by the seismic sources at different locations (e.g., first positions, second positions) using the sensors in the ocean bottom nodes, sensors towed along with the sources, or the like. As such, the acquired seismic wavefields may be processed (e.g., interpolated into regular distributions) to provide representations of subsurface layers of the Earth.

It should be noted that, the above examples in are for illustration. Although certain specific values (e.g., 10-, 15-, 20-, or 25-meters source spacing, 25-, 50-, 100-, or 250-meters node spacing) are used to describe disclosed embodiments, they should be understood as approximate values and may be more or less than 5-10% of the listed values. In addition, the random perturbation σ may be less or more than the numbers used in these examples. The randomization of the sail line separations and the source line spacings may help to avoid a regular alias pattern and enable improved subsequent image reconstruction (or direct imaging in some embodiments) base on the acquired survey data. Moreover, the overall number of sail lines and hence the time required to cover a given area may be reduced, which may reduce the survey time when coordinated with other field equipment to schedule the acquisition process. Thus, the randomization of the sail line separations and the source line spacings may also enable using compressive sensing techniques to maximize the ability to recover data. In some embodiments, compressive sensing techniques may include one or more of data interpolation, data reconstruction, and geometrical regularization (e.g., rearranging the data to provide a geometry with respect to the traces and intermediate processing results that may enable subsequent image reconstruction based on the acquired data).

Although the examples described above are illustrated for source boats in the OBN case, similar method may be applied to any acquisition configuration with lines and equipment transitioning the survey area. For example, the same incremental move up amount technique may be applied to land source seismic lines so that source line move ups after the original source line is shot may be moved up by a random amount (e.g., 300 m+σ) or selected from a predefined sequence (e.g., 300 m+σ, where σ may be selected from a varying sequence of distances such as 300, 190, 250, 290, 380, etc.).

A variety of physical and/or geological considerations may influence survey design in some locations. As one non-limiting example, regions of the Suez Canal are Oil & Gas production areas, yet the canal itself is also a major shipping lane, which therefore has exclusion zones where marine vessels cannot survey. Moreover, there may be pipelines or other infrastructure that influences survey design and where equipment can be placed or deployed. Additionally, geological formations, such as cliffs, hills, and other land features may influence survey design. Finally, in any transition zone area, i.e., the area between a body of water and the land, such as near the shoreline in which the water is too shallow for marine seismic data acquisition with typical towed streamers, additional challenges may arise in survey equipment placement, activation, and seismic data collection because of geological, environmental, and/or regulatory restrictions.

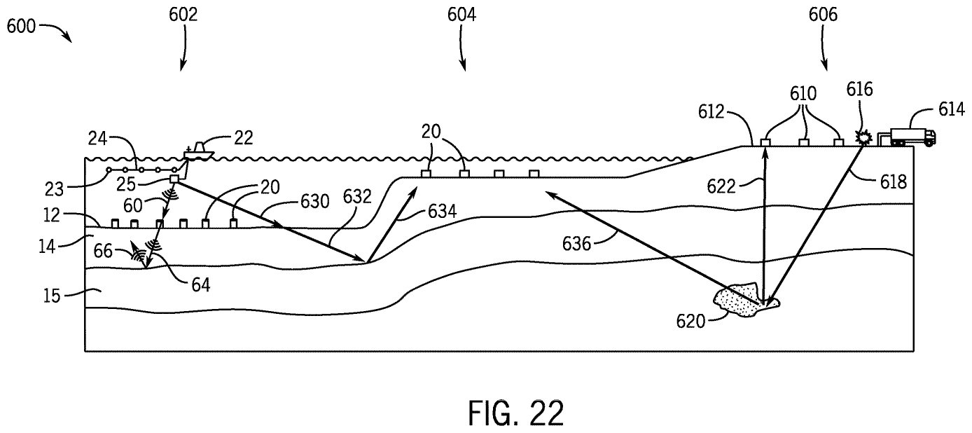

In some embodiments to address the aforementioned survey design challenges, a combination of land-based seismic sources and marine-based seismic sources may be used in a single survey, as illustrated in FIG. 22. For example a land-based seismic source can be a thumper truck, vibroseis truck, explosives, or even a sledgehammer to generate a seismic energy signal to propagate in the subsurface. Marine-based seismic sources may be a boomer source, a plasma sound source, explosives, a marine vibrator, and commonly used pneumatic sources such as an air gun, which come in different styles such as for shallow water and/or for deep water.

FIG. 22 is a schematic diagram of a seismic survey 600 including a body of water 602, a transition zone 604, and an on-shore area 606. The body of water area 602 may correspond to an area for conducting a marine seismic survey (e.g., the seismic survey illustrated in FIG. 1), while the on-shore area 606 may correspond to an area for conducting a land seismic survey. As mentioned previously in FIG. 1, the marine seismic survey in the body of water 602 may include OBN measurements by employing multiple OBNs 20 on the water bottom 12, and the acquired seismic data may be used to image the water bottom 12, the subsurface layers 14 and 15, and any geological structures (e.g., the geological structures 16 and 18). For example, one or more seismic source vessels (e.g., the source vessel 22) may be used in the marine seismic survey in the body of water 602. For example, the source vessel 22 may tow multiple (e.g., two, four, six, eight, or ten) streamers 23 along one sail line, and each of the streamers 23 may include streamer sensors 24. During the seismic survey, the seismic source 25 towed by the source vessel 22 may be activated to generate seismic waves 60 traveling downward into the subterranean geologic structures (e.g., the geological structures 16 and 18). When the seismic waves 60 arrives at the water bottom 12, a portion of seismic energy contained in the seismic waves 60 is reflected by the water bottom 12. Reflected waves travel upward and arrive at different sensors, such as the streamer sensors 24. Another portion of the seismic energy contained in transmitted seismic waves 64 propagates through the water bottom 12 into the subsurface layer 14. A portion of seismic energy contained in the transmitted waves 64 is reflected by the geological formation (e.g., geological formation 72), and the reflected waves 66 travel upward and arrive at the different sensors.

In the on-shore area 606, one or more land-based sensors 610 are dispersed across the surface 612 to form a grid-like pattern. One or more land-based seismic sources 616 (e.g., seismic vibrator) may be towed by one or more vehicles 614 and disposed on the surface 612. In some embodiments, the land-based seismic sources 616 may be a thumper truck, vibroseis truck, explosives, or even a sledgehammer. The land-based seismic source 616 may produce energy output 618 (e.g., sound waves, seismic waveforms), which may travel downward into the subterranean geologic structures. Upon reaching various geological formations 620 (e.g., salt domes, faults, folds, hydrocarbon deposits) within the subsurface region, the energy output 618 generated by the land-based seismic source 616 may be reflected off of the geological formations 80. The reflected energy output 622 may be acquired or recorded by the one or more land-based sensors 610.

In addition, the seismic survey methods and techniques described herein may be performed to obtain seismic data related to subterranean regions of the transition zone 604. That is, the shallower portions of the body of water 602 that correspond to the transition zone 604 may use the marine seismic survey techniques, the land seismic survey techniques, or both to acquire the seismic data associated with the transition zone 604. For example, multiple OBNs 20 may be employed on a portion of the water bottom 12 in the transition zone 604, and the acquired seismic data may be used to image the portion of the water bottom 12 in the transition zone 604, a portion of the subsurface layers 14 and 15 in the transition zone 604, or any geological structures in the transition zone 604. For example, a seismic wave 630 may be generated by the seismic source 25 and arrive at the portion of the water bottom 12 in the transition zone 604, and a portion of seismic energy contained in the seismic wave 630 may be reflected or scattered. The reflected or scattered wave 634 may travel upward and arrive at some of the multiple OBNs 20 employed in the transition zone 604. In addition, the multiple OBNs 20 employed in the transition zone 604 may also receive a seismic wave 636 reflected or scattered from the geological formations 620 (e.g., salt domes, faults, folds, hydrocarbon deposits). For example, the energy output 618 generated by the land-based seismic sources 616 may be reflected or scattered by the geological formations 620. Sometime, a portion of the geological formations 620 may be in or near the transition zone 604. Indeed, it should be understood that any suitable technique describe above may be modified to accommodate the features of the transition zone 604, which may generally include the area between the body of water 602 and the on-shore area 606 (e.g., land). However, additional processes (e.g., equipment, survey techniques, data processing) may be used to account for the geological, environmental, and/or regulatory restrictions associated with the transition zone 604.

The techniques and methods disclosed herein may be used to accelerate the transition of the seismic survey while providing adequate data quality and remaining within the operational constraints of the field equipment. In some embodiments, the survey techniques disclosed herein may include reconstructing an image from the acquired data, wherein the reconstruction is based in part on inversion (e.g., FWI or other inversion techniques that will be appreciated by those skilled in the art). In some embodiments, the survey techniques may include reconstructing an image from the acquired data, and the reconstruction may be based in part on an imaging algorithm. In some embodiments, the acquired data may be processed with one or more compressive sensing techniques before the image reconstruction. Therefore, the techniques and methods disclosed herein may substantially reduce survey costs by reducing number of shot lines/acquisition lines, and hence survey duration. The techniques and methods disclosed herein may be used in various kinds of seismic acquisitions, such as adjusting source vessel(s) properties in a sparse acquisition, gaining greater coverage in a given amount of time.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

In one embodiment, a method for seismic surveying is provided that includes activating one or more of a plurality of seismic sources simultaneously or independently at one or more first positions; activating at least one of the plurality of seismic sources at one or more second positions displaced by a first distance from the one or more first positions; activating at least one of the plurality of seismic sources at one or more third positions displaced by a second distance from the one or more second positions, wherein the second distance is different from the first distance; and after activating the plurality of seismic sources, collecting seismic survey data via a plurality of seismic sensors positioned at regular or irregular intervals.

Those with skill in the art will recognize that, in accordance with some embodiments disclosed herein, seismic survey data collection may occur during or after time 1, which is activating at least one source at the first position, and/or during or after time 2, which is activating at least one source at the second position, and/or during or after time 3, which is activating at least one source at the third position. To wit, seismic data collection may occur at various specific times during the survey, or there may also be continuous seismic data collection during a series of seismic source activations. And some seismic sensors may be configured for continuous collection, while other sensors may be configured to collect at specific times during the survey.

In varying embodiments, the aforementioned survey method may be used in a transition zone where some sources are placed on shore, e.g., a vibroseis truck, and one or more vessels may tow marine seismic source(s), such as a vibrator, or an airgun, or both. In transition zone surveys, shallow-water airguns may be particularly helpful. For receiving the seismic survey data, the plurality of seismic sensors may include land-based geophones or other seismic sensors, and marine-based hydrophones or other seismic sensors, such as a seismic streamer with multiple sensors to receive the seismic survey data. In some circumstances, ocean bottom nodes with marine-based seismic sensors may also be deployed in the water to receive the seismic survey data. Those with skill in the art will recognize that many combinations of sources and sensors are possible to implement the invention.

In one embodiment, a method for performing a seismic survey is provided that includes: activating one or more towed seismic sources simultaneously or independently at one or more first positions; activating the one or more towed seismic sources at one or more second positions displaced by a first distance from the one or more first positions; activating the one or more towed seismic sources at one or more third positions displaced by a second distance from the one or more second positions, wherein the second distance is different from the first distance; and after activating the one or more towed seismic sources, collecting seismic survey data via a plurality of ocean bottom nodes (or sensors) positioned at regular or irregular intervals on or at a water bottom in a seismic survey area.

In additional embodiments, the second distance is a random value.

In additional embodiments, the second distance is selected from a predefined sequence.

In additional embodiments, the one or more first positions are along one or more first sail lines, the one or more second positions are along one or more second sail lines, and the one or more third positions are along one or more third sail lines, wherein the one or more second sail lines are displaced by the first distance from the one or more first sail lines, and the one or more third sail lines are displaced by the second distance from the one or more second sail lines.

In some of the foregoing additional embodiments, a plurality of source lines is collected for one or more sail lines of the one or more first sail lines, the one or more second sail lines, and the one or more third sail lines.

In some of the foregoing additional embodiments, the one or more towed seismic sources comprise a plurality of seismic sources separated by one or more separations, and at least one of the one or more separations is a random perturbation in a crossline direction.

In some of the foregoing additional embodiments, the one or more towed seismic sources comprise a plurality of seismic sources separated by one or more separations, and at least one of the one or more separations is fixed for a duration of the marine seismic survey.

In some of the foregoing additional embodiments, the first distance corresponds to a crossline direction relative to the one or more first positions.

In additional embodiments, the method for performing a seismic survey further includes reconstructing an image from the collected seismic survey data based in part on an inversion technique.

In additional embodiments, the method for performing a seismic survey further includes reconstructing an image from the collected seismic survey data based in part on an imaging algorithm.

In some of the foregoing additional embodiments, the collected seismic survey data is processed with one or more compressive sensing techniques before the reconstruction.

In additional embodiments, the method for performing a seismic survey further includes determining a plurality of parameters associated with the plurality of ocean bottom nodes (or sensors) and the one or more towed seismic sources based at least on a full waveform inversion (FWI) analysis.

In additional embodiments, the plurality of ocean bottom nodes (or sensors) are spaced apart from one another by distances between 800 meters to 1600 meters. When performing some surveys, such as a time-lapse survey, some embodiments may have denser sensor grids for the plurality of ocean bottom sensors that use smaller sensor separation distances, e.g., 200 meters, 300 meters, 400 meters, 600 meters, or any other interval, including less separation distance than even 200 meters. In some embodiments, the sensor grid may include irregular separations, e.g., 200 meters in one direction and 400 meters in a different direction.

In some of the foregoing additional embodiments, a source grid of the one or more towed seismic sources is denser than an ocean bottom sensor grid of the plurality of ocean bottom sensors, and wherein the one or more towed seismic sources are separated by a fraction of a wavelength of seismic wavefields generated by the one or more towed seismic sources, comprising 50 meters, 100 meters, or any other intervals.

In some of the foregoing additional embodiments, the one or more towed seismic sources are selected from the group consisting of pneumatic sources and marine vibrators.

In some of the foregoing additional embodiments, the one or more towed seismic sources are pneumatic sources configured to be activated with time delays designed to improve efficiency and subsurface illumination.

In some of the foregoing additional embodiments, the time delays vary in a range from zero to a duration that extends beyond the maximum reflection time from a deep event of interest.

In some of the foregoing additional embodiments, the method for performing a seismic survey further includes separating the seismic wavefields from different seismic sources of the one or more towed seismic sources using the time delays. In some further embodiments, the separation may be performed by numeric processing.

In some of the foregoing additional embodiments, the one or more towed seismic sources are marine vibrators configured to activate sweeps that improve efficiency and subsurface illumination.

In some of the foregoing additional embodiments, the method for performing a seismic survey further includes separating the seismic wavefields from different seismic sources using the sweeps. In some further embodiments, the separation may be performed by numeric processing.

In some of the foregoing additional embodiments, the sweeps are configured to tune low frequencies for sparse geometries.

In some of the foregoing additional embodiments, the one or more towed seismic sources include marine vibrators and pneumatic sources.

In one embodiment, a method for performing a seismic survey is provided that includes: activating one or more towed seismic sources simultaneously or independently at one or more first positions; activating the one or more towed seismic sources at one or more second positions displaced by a first distance from the one or more first positions; activating the one or more towed seismic sources at one or more third positions displaced by a second distance from the one or more second positions, wherein the second distance is different from the first distance; and after activating the one or more towed seismic sources, collecting seismic survey data via a plurality of seismic streamers that include sensors. In some embodiments, the sensors are hydrophones. In some embodiments, the sensors are multicomponent sensors. In some embodiments, the sensors are optical sensors. In some embodiments, the sensors employ distributed acoustic sensor capabilities.

In additional embodiments, the second distance is a random value.

In additional embodiments, the second distance is selected from a predefined sequence.

In additional embodiments, the one or more first positions are along one or more first sail lines, the one or more second positions are along one or more second sail lines, and the one or more third positions are along one or more third sail lines, wherein the one or more second sail lines are displaced by the first distance from the one or more first sail lines, and the one or more third sail lines are displaced by the second distance from the one or more second sail lines.

In some of the foregoing additional embodiments, a plurality of source lines is collected for one or more sail lines of the one or more first sail lines, the one or more second sail lines, and the one or more third sail lines.

In some of the foregoing additional embodiments, the one or more towed seismic sources comprise a plurality of seismic sources separated by one or more separations, and at least one of the one or more separations is a random perturbation in a crossline direction.

In some of the foregoing additional embodiments, the one or more towed seismic sources comprise a plurality of seismic sources separated by one or more separations, and at least one of the one or more separations is fixed for a duration of the marine seismic survey.

In some of the foregoing additional embodiments, the first distance corresponds to a crossline direction relative to the one or more first positions.

In additional embodiments, the method for performing a seismic survey further includes reconstructing an image from the collected seismic survey data based in part on an inversion technique.

In additional embodiments, the method for performing a seismic survey further includes reconstructing an image from the collected seismic survey data based in part on an imaging algorithm.

In some of the foregoing additional embodiments, the collected seismic survey data is processed with one or more compressive sensing techniques before the reconstruction

In additional embodiments, the method for performing a seismic survey further includes determining a plurality of parameters associated with the sensors and the one or more towed seismic sources based at least on a full waveform inversion (FWI) analysis.

In additional embodiments, the sensors are spaced apart from one another by distances between 800 meters to 1600 meters.

In some of the foregoing additional embodiments, a source grid of the one or more towed seismic sources is denser than a sensor grid of the sensors, and wherein the one or more towed seismic sources are separated by a fraction of a wavelength of seismic wavefields generated by the one or more towed seismic sources, comprising 50 meters, 100 meters, or any other intervals.

In some of the foregoing additional embodiments, the one or more towed seismic sources are selected from the group consisting of pneumatic sources and marine vibrators.

In some of the foregoing additional embodiments, the one or more towed seismic sources are pneumatic sources configured to be activated with time delays designed to improve efficiency and subsurface illumination.

In some of the foregoing additional embodiments, the time delays vary in a range from zero to a duration that extends beyond the maximum reflection time from a deep event of interest.

In some of the foregoing additional embodiments, the method for performing a seismic survey further includes separating the seismic wavefields from different seismic sources of the one or more towed seismic sources using the time delays.

In some of the foregoing additional embodiments, the one or more towed seismic sources are marine vibrators configured to activate sweeps that improve efficiency and subsurface illumination.

In some of the foregoing additional embodiments, the method for performing a seismic survey further includes separating the seismic wavefields from different seismic sources using the sweeps.

In some of the foregoing additional embodiments, the sweeps are configured to tune low frequencies for sparse geometries.

In some of the foregoing additional embodiments, the one or more towed seismic sources include marine vibrators and pneumatic sources.

In one embodiment, a method for performing a seismic survey is provided that includes: activating one or more of a plurality of seismic sources simultaneously or independently at one or more first positions; activating at least one of the plurality of seismic sources at one or more second positions displaced by a first distance from the one or more first positions; activating at least one of the plurality of seismic sources at one or more third positions displaced by a second distance from the one or more second positions, wherein the second distance is different from the first distance; and after activating the plurality of seismic sources, collecting seismic survey data via a plurality of seismic sensors positioned at regular or irregular intervals.

In additional embodiments, the second distance is a random value.

In additional embodiments, the second distance is selected from a predefined sequence.

In additional embodiments, the one or more first positions are along one or more first source lines, the one or more second positions are along one or more second source lines, and the one or more third positions are along one or more third source lines, wherein the one or more second source lines are displaced by the first distance from the one or more first source lines, and the one or more third source lines are displaced by the second distance from the one or more second source lines.

In some of the foregoing additional embodiments, a plurality of source lines is collected for one or more source lines of the one or more first source lines, the one or more second source lines, and the one or more third source lines.

In some of the foregoing additional embodiments, the plurality of seismic sources are separated by one or more separations, and at least one of the one or more separations is a random perturbation in a crossline direction.

In some of the foregoing additional embodiments, the plurality of seismic sources are separated by one or more separations, and at least one of the one or more separations is fixed for a duration of the seismic survey. In alternative embodiments, at least one of the one or more separations may vary during the seismic survey.

In some of the foregoing additional embodiments, the first distance corresponds to a crossline direction relative to the one or more first positions.

In additional embodiments, the method for performing a seismic survey also includes reconstructing an image from the collected seismic survey data based in part on an inversion technique.

In additional embodiments, the method for performing a seismic survey also includes reconstructing an image from the collected seismic survey data based in part on an imaging algorithm.

In some of the foregoing additional embodiments, the collected seismic survey data is processed with one or more compressive sensing techniques before the reconstruction.

In additional embodiments, the method for performing a seismic survey also includes determining a plurality of parameters associated with the plurality of seismic sensors and the plurality of seismic sources based at least on a full waveform inversion (FWI) analysis.

In additional embodiments, at least two of the plurality of seismic sensors are spaced apart from one another by distances between 100 meters to 1600 meters, or any other intervals suitable for the survey area and intended survey design.

In some of the foregoing additional embodiments, a source grid of the plurality of seismic sources is denser than a sensor grid of the plurality of seismic sensors, and wherein the plurality of seismic sources are separated by a fraction of a wavelength of seismic wavefields generated by the plurality of seismic sources, comprising 50 meters, 100 meters, or any other intervals.

In some of the foregoing additional embodiments, the plurality of seismic sources are selected from the group consisting of marine-based seismic sources and land-based seismic sources.

In some of the foregoing additional embodiments, the plurality of marine-based seismic sources include pneumatic sources configured to be activated with time delays designed to improve efficiency and subsurface illumination.

In some of the foregoing additional embodiments, the time delays vary in a range from zero to a duration that extends beyond the maximum reflection time from a deep event of interest.

In some of the foregoing additional embodiments, the method for performing a seismic survey also includes separating the seismic wavefields from different seismic sources of the plurality of marine-based seismic sources using the time delays.

In some of the foregoing additional embodiments, the plurality of marine-based seismic sources include marine vibrators configured to activate sweeps that improve efficiency and subsurface illumination.

In some of the foregoing additional embodiments, the method for performing a seismic survey also includes separating the seismic wavefields from different seismic sources using the sweeps.

In some of the foregoing additional embodiments, the sweeps are configured to tune low frequencies for sparse geometries.

In some of the foregoing additional embodiments, the plurality of marine-based seismic sources include marine vibrators and pneumatic sources.

In some of the foregoing additional embodiments, the plurality of seismic sources include land-based seismic sources configured to be activated with time delays designed to improve efficiency and subsurface illumination.

In some of the foregoing additional embodiments, the plurality of seismic sensors include a plurality of marine-based and land-based seismic sensors.

In some of the foregoing additional embodiments, the seismic survey is in a transition zone.

In some of the foregoing additional embodiments, the plurality of marine-based seismic sensors are disposed in one or more ocean bottom nodes.

In some of the foregoing additional embodiments, the plurality of marine-based seismic sensors are part of one or more seismic streamers.

In some of the foregoing additional embodiments, a time-lapse survey is performed, which includes at least performing the seismic survey at least a second time to determine changes in an area of interest over time. In some time-lapse embodiments, the seismic survey is performed repeatedly during a time period to determine changes over that time period.

In some of the foregoing additional embodiments, the area of interest is selected from the group consisting of an oil reservoir, a gas reservoir, a water aquifer, a depleted oil reservoir, a depleted gas reservoir, and a carbon storage reservoir.

In some of the foregoing additional embodiments, the method also includes detecting leakage, migration, degradation, or other carbon storage reservoir problems.

In some of the foregoing additional embodiments, the collection of seismic survey data is continuous.

In some of the foregoing additional embodiments, the collection of seismic survey data is performed after each source activation.

In one embodiment, a method for performing a seismic survey is provided that includes: at a first time, activating one or more of a plurality of seismic sources simultaneously or independently; at a second time, activating at least one of the plurality of seismic sources at one or more second positions displaced by a first distance from the one or more first positions; at a third time, activating at least one of the plurality of seismic sources at one or more third positions displaced by a second distance from the one or more second positions, wherein the second distance is different from the first distance; and after activating the plurality of seismic sources, collecting seismic survey data via a plurality of seismic sensors positioned at regular or irregular intervals. This method may be used repeatedly over time to perform time-lapse seismic survey analysis.

In some of the foregoing additional embodiments, the seismic survey is in a transition zone.

In some of the foregoing additional embodiments, at least one seismic source is changing position between activations, and at least one seismic source is at a fixed location. In some embodiments, the seismic source changing position between activations is a towed marine source. In some embodiments, the seismic source changing position between activations is a land-based source, such as a vibroseis truck. In some embodiments, the seismic source at a fixed location is a land-based source. In some embodiments, the second time is after a random duration from the first time. In some embodiments, the second time is after a duration selected from a predefined sequence of source activation timings (e.g., first activation time W, second activation time X, third activation time Y, fourth activation time Z, and repeat through W, X, Y, and Z timing for subsequent source activations; any suitable time durations and the number of predefined sequence durations, such as W-Z in this example, may be used in accordance with these embodiments).

Those with skill in the art will appreciate that use of the term ‘random’ in this disclosure need not strictly mean purely random numbers because many computing systems will generate a random number upon request, where, in fact, the generated random number is a pseudo-random number provided by an algorithm.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. § 112 (f). However, for any claims containing elements designated in any other manner, it is intended that such elements are not to be interpreted under 35 U.S.C. § 112 (f).

1. A method for performing a marine seismic survey, comprising:
activating one or more towed seismic sources simultaneously or independently at one or more first positions;
activating the one or more towed seismic sources at one or more second positions displaced by a first distance from the one or more first positions; and
activating the one or more towed seismic sources at one or more third positions displaced by a second distance from the one or more second positions, wherein the second distance is different from the first distance.

2. The method of claim 1, after activating the one or more towed seismic sources, collecting seismic survey data via a plurality of ocean bottom sensors positioned at regular or irregular intervals on or at a water bottom in a seismic survey area.

3. The method of claim 1, after activating the one or more towed seismic sources, collecting seismic survey data via a plurality of seismic streamers that include sensors.

4. The method of claim 1, wherein the one or more first positions are along one or more first sail lines, the one or more second positions are along one or more second sail lines, and the one or more third positions are along one or more third sail lines, wherein the one or more second sail lines are displaced by the first distance from the one or more first sail lines, and the one or more third sail lines are displaced by the second distance from the one or more second sail lines.

5. The method of claim 4, wherein a plurality of source lines is collected for one or more sail lines of the one or more first sail lines, the one or more second sail lines, and the one or more third sail lines.

6. The method of claim 4, wherein the one or more towed seismic sources comprise a plurality of seismic sources separated by one or more separations, and at least one of the one or more separations is a random perturbation in a crossline direction.

7. The method of claim 4, wherein the one or more towed seismic sources comprise a plurality of seismic sources separated by one or more separations, and at least one of the one or more separations is fixed for a duration of the marine seismic survey.

8. The method of claim 4, wherein the first distance corresponds to a crossline direction relative to the one or more first positions.

9. The method of claim 1, further comprising reconstructing an image from the collected seismic survey data based in part on an inversion technique.

10. The method of claim 1, further comprising reconstructing an image from the collected seismic survey data based in part on an imaging algorithm.

11. The method of claim 10, wherein the collected seismic survey data is processed with one or more compressive sensing techniques before the reconstruction.

12. The method of claim 2, further comprising:
determining a plurality of parameters associated with the plurality of ocean bottom sensors and the one or more towed seismic sources based at least on a full waveform inversion (FWI) analysis.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. The method of claim 1, wherein the second distance is a random value.

25. The method of claim 1, wherein the second distance is selected from a predefined sequence.

26. (canceled)

27. (canceled)

28. (canceled)

29. (canceled)

30. (canceled)

31. (canceled)

32. (canceled)

33. (canceled)

34. The method of claim 3, further comprising:
determining a plurality of parameters associated with the sensors and the one or more towed seismic sources based at least on a full waveform inversion (FWI) analysis.

35. (canceled)

36. (canceled)

37. (canceled)

38. (canceled)

39. (canceled)

40. (canceled)

41. (canceled)

42. (canceled)

43. (canceled)

44. (canceled)

45. A method for performing a seismic survey, comprising:
activating one or more of a plurality of seismic sources simultaneously or independently at one or more first positions;
activating at least one of the plurality of seismic sources at one or more second positions displaced by a first distance from the one or more first positions;
activating at least one of the plurality of seismic sources at one or more third positions displaced by a second distance from the one or more second positions, wherein the second distance is different from the first distance; and
after activating the plurality of seismic sources, collecting seismic survey data via a plurality of seismic sensors positioned at regular or irregular intervals.

46. (canceled)

47. (canceled)

48. The method of claim 45, wherein the one or more first positions are along one or more first source lines, the one or more second positions are along one or more second source lines, and the one or more third positions are along one or more third source lines, wherein the one or more second source lines are displaced by the first distance from the one or more first source lines, and the one or more third source lines are displaced by the second distance from the one or more second source lines.

49. (canceled)

50. (canceled)

51. (canceled)

52. (canceled)

53. (canceled)

54. (canceled)

55. (canceled)

56. The method of claim 45, further comprising:
determining a plurality of parameters associated with the plurality of seismic sensors and the plurality of seismic sources based at least on a full waveform inversion (FWI) analysis.

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. The method of claim 45, further comprising performing the seismic survey a second time to determine changes in an area of interest over time.

73. (canceled)

74. (canceled)

75. (canceled)

76. (canceled)

77. (canceled)

78. (canceled)

79. (canceled)

80. (canceled)

81. (canceled)

82. (canceled)
